(19) United States
(12) Patent Application Publication
(10) Pub. No.: US 2014/0013192 A1
(43) Pub. Date: Jan. 9, 2014

(54) TECHNIQUES FOR TOUCH-BASED DIGITAL DOCUMENT AUDIO AND USER INTERFACE ENHANCEMENT

(71) Applicants: Scott McQuiggan, Raleigh, NC (US); Jennifer Sabourin, Cary, NC (US); Philippe Sabourin, Cary, NC (US)

(72) Inventors: Scott McQuiggan, Raleigh, NC (US); Jennifer Sabourin, Cary, NC (US); Philippe Sabourin, Cary, NC (US)

(73) Assignee: SAS Institute Inc., Cary, NC (US)

(21) Appl. No.: 13/544,442

(22) Filed: Jul. 9, 2012

(51) Int. Cl. G06F 17/00; H04B 1/38

(52) U.S. Cl. 715/203

(57) ABSTRACT

Techniques for digital document audio and user interface enhancement are generally described herein. In one embodiment, for example, an apparatus may comprise a processor circuit and a digital document application operative on the processor circuit. The digital document application may comprise a document recorder component arranged for execution by the processor circuit to receive a source document file and generate an annotated document file, the document recorder component arranged to retrieve a text element from the source document file, generate a user interface view with the text element and an audio narration guide proximate to the text element for presentation on an output device, receive positions of an object on the audio narration guide from an input device, and generate an audio element for the text element based on the positions. Other embodiments are described and claimed.

### BACKGROUND

Reading is a fundamental skill of primary importance. Effective methods for teaching reading and interacting with digital content are highly sought after. For example, consumer demand for electronic books (e.g., eBooks) for consumption on mobile computing devices, such as table computing devices and dedicated electronic book readers (e.g., eReaders), is experiencing substantial growth. In addition, electronic books with audio narration are increasing in availability and popularity. However, challenges such as learning to read or effectively interacting with digital content are not overcome simply through the addition of technology. For example, adding narrative content to electronic books is currently a time-consuming and complicated process, performed mainly by digital content publishers and users having a high level of software and computing device experience. In addition, user interaction with digital content, including eBooks and audio eBooks, is generally limited to traditional reading methods or passively following along with narrative content. For instance, users generally do not have the ability to adequately control the pace of narration beyond simple speed control functions (e.g., fast, normal, slow), to easily generate their own narrative content, or to interact with the digital document content in a meaningful, intuitive manner.

It is with respect to these and other considerations that the present improvements have been needed.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques to enhance digital documents with audio content, user interface components, or both. Audio content may refer to audio data associated with the text of a digital document, for example, a voice narration of the text. Some embodiments are particularly directed to techniques to record and synchronize audio content with digital document text. In one embodiment, word-level recording of audio content may be implemented through a touch-based interface configured to record a user reading text aloud and to receive touch input indicating a current position within the text. User interface components may refer to touch-based components integrated with the digital document text, for example, in a manner that supports reading or the recording of audio content. For instance, an embodiment may provide an audio narration guide component positioned proximate to digital document text presented on an electronic display device configured to receive touch input. The audio narration guide may operate to track the position of an object, such as a human finger. In one embodiment, an audio narration guide component may allow a user to control the pacing of audio content playback associated with the digital document. In another embodiment, the audio narration guide may operate to facilitate listening to a user reading digital document text aloud, for example, as part of a system that monitors reading comprehension, fluency, pronunciation, context-awareness, word recognition, and letter identification, among other language features.

In one embodiment, for example, an apparatus may comprise a processor circuit and a digital document application operative on the processor circuit to generate a digital document associated with an audio element. The apparatus may also comprise a document recorder component arranged for execution by the processor circuit. The document recorder component may be configured to receive a source document file and generate an annotated document file, the document recorder component arranged to retrieve a text element from the source document file, generate a user interface view with the text element and an audio narration guide proximate to the text element for presentation on an output device, receive positions of an object on the audio narration guide from an input device, and generate an audio element for the text element based on the positions. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a digital document apparatus.

FIG. 2A illustrates an embodiment of a first logic flow.

FIG. 2B illustrates an embodiment of a first logic flow.

FIG. 3 illustrates an embodiment of a device implementing text element selection.

FIG. 4 illustrates a first embodiment of a device implementing audio element recording.

FIG. 5 illustrates a second embodiment of a device implementing audio element recording.

FIG. 6 illustrates a third embodiment of a device implementing audio element recording.

FIG. 7 illustrates a first embodiment of a device implementing a reading user interface view.

FIG. 8 illustrates a second embodiment of a device implementing a reading user interface view.

FIG. 9 illustrates an embodiment of a first data model.

FIG. 10 illustrates an embodiment of a second data model.

FIG. 11 illustrates an embodiment of a third data model.

FIG. 12 illustrates an embodiment of a fourth data model.

FIG. 13 illustrates an embodiment of a fifth data model.

FIG. 14 illustrates an embodiment of a sixth data model.

FIG. 15 illustrates an embodiment of a text element configuration process.

FIG. 16 illustrates an example embodiment of a first object contact state.

FIG. 17 illustrates an example embodiment of a second object contact state.

FIG. 18 illustrates an example embodiment of a third object contact state.

FIG. 19 illustrates an example embodiment of a text-level recording.

FIG. 20 illustrates an example embodiment of a touch-based timing.

FIG. 21 illustrates an example embodiment of a touch-based speech recognition.

FIG. 22 illustrates an embodiment of a centralized system for the apparatus of FIG. 1.

FIG. 23 illustrates an embodiment of a distributed system for the apparatus of FIG. 1.

FIG. 24 illustrates an embodiment of a computing architecture.

FIG. 25 illustrates an embodiment of a communications architecture.

### DETAILED DESCRIPTION

Various embodiments are directed to touch-based techniques for generating and interacting with digital documents augmented with audio content, user interface components, or both. Some embodiments may provide touch-based user interfaces configured for presentation on electronic touch-input capable display devices, such as a touch-screen of a mobile computing device. The touch-based user interfaces may be arranged to record, synchronize, or playback audio content associated with digital document text according to received touch input.

In particular, embodiments may provide user interfaces displaying digital document text and user interface components associated with the text. According to embodiments, the user interface components may comprise elements such as bars, dots, lines, boxes, or a combination thereof arranged beneath each line of text, around each word of the text, or otherwise arranged proximate to the text. The user interface components may be configured as visible or invisible active zones accessible through a user interface device, such as a touch-input capable display device, for example. A user may indicate active text by touching a user interface component associated with the particular text, for example, by tapping on a user interface component or sliding a human finger across a user interface component. According to embodiments, audio content may be generated for a digital document by synchronizing recorded audio with text placed in focus based on touch input. In one embodiment, a user may interact with the user interface by sliding a finger across the user interface components in a manner that indicates a pace of reading of the associated text. A user may therefore finely control the rate of audio content playback when reading digital document text. In addition, a user may slide a finger along the text while reading aloud, allowing a speech recognition component to listen to the spoken words, for example, to monitor reading comprehension. As a result, the embodiments may enrich user experiences with digital documents and improve the efficiency and effectiveness of generating, reading, and learning from enhanced digital documents.

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

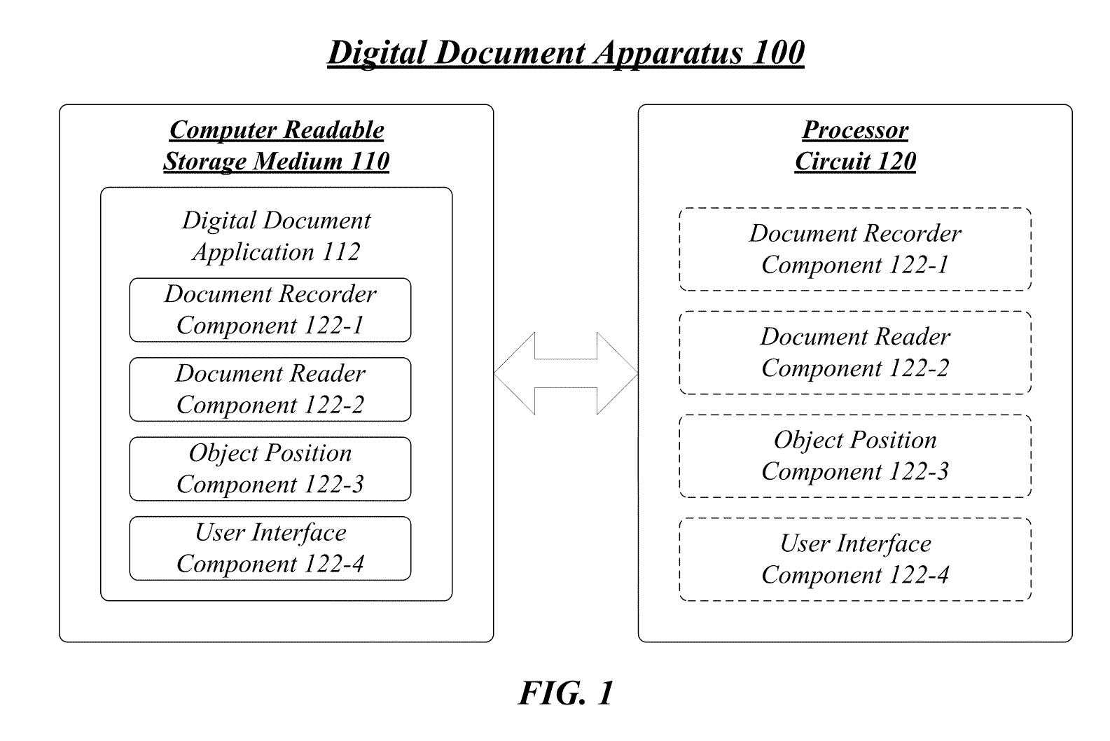

FIG. 1 illustrates a block diagram for a digital document apparatus 100. Although the digital document apparatus 100 shown in FIG. 1 has a limited number of elements in a certain topology, it may be appreciated that the digital document apparatus 100 may include more or less elements in alternate topologies as desired for a given implementation. In various embodiments, the digital document apparatus 100 may comprise or implement multiple components or modules. As used herein the terms “component” and “module” are intended to refer to computer-related entities, comprising either hardware, a combination of hardware and software, software, or software in execution. For example, a component and/or module can be implemented as a process running on a processor, a hard disk drive, multiple storage drives (of optical and/or magnetic storage medium), an object, an executable, a thread of execution, a program, and/or a computer. By way of illustration, both an application running on a computing device and the computing device can be a component and/or module. One or more components and/or modules can reside within a process and/or thread of execution, and a component and/or module can be localized on one computing device and/or distributed between two or more computing devices as desired for a given implementation. The embodiments are not limited in this context.

In various embodiments, the digital document apparatus 100 may be implemented by one or more electronic devices each having computing and/or communications capabilities. Example computing devices may include without limitation a mobile device, a personal digital assistant, a mobile computing device, a smart phone, a cellular telephone, an electronic reader (e.g., e-reader or eReader), an electronic book reader (e.g., an e-reader or eBook reader), a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a mainframe computer, a supercomputer, a network appliance, a web appliance, multiprocessor systems, processor-based systems, or any combination thereof. The embodiments are not limited in this context.

In various embodiments, components and/or modules of the digital document apparatus 100, and any electronic devices implementing some or all of the components and/or modules of the digital document apparatus 100, may be communicatively coupled via various types of communications media as indicated by various lines or arrows. The devices, components and/or modules may coordinate operations between each other. The coordination may involve the uni-directional or bi-directional exchange of information. For instance, the devices, components and/or modules may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections within a device include parallel interfaces, serial interfaces, and bus interfaces. Exemplary connections between devices may comprise network connections over a wired or wireless communications network.

In various embodiments, the digital document apparatus 100 may comprise a computer readable storage medium 110 communicatively coupled with a processor circuit 120. The digital document apparatus 100 may further have installed a digital document application 112. The digital document application 112 may be generally arranged to retrieve text elements from digital documents accessible from the digital document apparatus for presentation on a user interface in association with audio content, user interface components, or some combination thereof. For example, the digital document application may present a user interface comprising text elements and an audio narration guide user interface component located proximate to the text elements. In one embodiment, the audio narration guide may receive touch input comprising position information of a human finger on the audio narration guide. The digital document application may generate audio elements for the text elements based on the position information.

The computer readable storage medium 110 may store an unexecuted version of the digital document application 112 as well as other information, including, without limitation, digital documents, annotated digital documents, and audio data. The computer readable storage medium 110 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD)), hard disk drives (HDD), and any other type of storage media suitable for storing information.

The processor circuit 120 may be communicatively coupled with the computer readable storage medium 110 such that the digital document application 112, and components thereof, may be arranged for execution by the processor circuit. The processor circuit 120 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Core (2) Quad®, Core i3®, Core i5®, Core i7®, Atom®, Itanium®, Pentium®, Xeon®, and XScale® processors; and similar processors. Dual microprocessors, multi-core processors, and other multi-processor architectures may also be employed as the processor circuit 120.

The digital document application 112 may comprise one or more components 122-a. Although the digital document application 112 shown in FIG. 1 has a limited number of elements in a certain topology, it may be appreciated that the digital document application 112 may include more or less elements in alternate topologies as desired for a given implementation.

It is worthy to note that “a” and “b” and “c” and similar designators as used herein are intended to be variables representing any positive integer. Thus, for example, if an implementation sets a value for a=5, then a complete set of components 122-a may include components 122-1, 122-2, 122-3, 122-4 and 122-5. The embodiments are not limited in this context.

In the illustrated embodiment shown in FIG. 1, the digital document application 112 may comprise a document recorder component 122-1, a document reader component 122-2, an object position component 122-3, and a user interface component 122-4. The embodiments are not limited in this context.

The document recorder component 122-1 may generally operate to receive a source document file and to generate an annotated document file based on the source document file. According to embodiments, annotated document files may be comprised of information obtained from the source document file, such as text, annotated with additional data or content, such as audio content, data related to audio content, metadata, or a file or a portion of a file corresponding to the text. The document recorder component 122-1 may be configured to retrieve text elements from a source document file. Text elements may be comprised of any usable level of text information, such as words, sentences, paragraphs, or pages of the source document file. The document recorder component may operate to generate audio elements associated with the text elements based on user input, such as touch input received through a user interface component and audio input received through one or more audio recording devices accessible by the digital document apparatus 100. For instance, the annotated document file may consist of digital document text and data comprising a voice narration of the text. The annotated document file may be configured to have a defined data format associated with a particular system, such as a particular electronic reader system or file format. In one embodiment, the source document file, annotated document file, or both may be in an EPUB® format, such as the EPUB® 3.0 Publications standard provided by the International Digital Publishing Forum. In another embodiment, audio elements may be configured as the Read Aloud EPUB® format as included in Apple® iBooks® version 1.3. Other formats are possible, including proprietary formats. The embodiments are not limited in this context.

The document reader component 122-2 may generally operate to retrieve information elements from a digital document file. In one embodiment, the document reader component may retrieve information elements from an annotated document file generated by the document recorder component 122-1. The information elements may include, but are not limited to, text elements, audio elements associated with the text elements, other data associated with the text elements, or combinations thereof. The document reader component may parse digital document text into individual text elements, including pages, paragraphs, sentences, and words, for example, using a lexical parser application, module, or plug-in. According to embodiments, the document reader component 122-2 may be configured to reproduce audio elements associated with text elements based on user input. In one embodiment, text elements retrieved from an annotated document file by the document reader component 122-2 may be displayed on an electronic display capable of accepting touch-based input. Responsive to touch input selecting a text element, for example, through touch-based selection of a user interface component associated with the text element, the document reader component 122-2 may reproduce the audio element associated with the text element. The embodiments are not limited in this context.

The object position component 122-3 may generally operate to receive object positions transmitted through an input device accessible by the digital document apparatus 100, and to communicate the object positions within the digital document application 112, for example, to the document recorder component 122-1 or the document reader component 122-2. In one embodiment, the input device comprises a touch-screen for an electronic display configured to receive positions of a human finger contacting the touch-screen. The object position component 122-3 may be configured according to embodiments to receive input based on object contact with one or more user interface components, such as an audio narration guide located proximate to text displayed on a user interface. In one embodiment, the object position component 122-3 may receive object position information in the form of an object sliding along one or more user interface components. The object position component 122-3 may communicate the sliding object position information within the digital document application 112 in a manner that indicates a pace of interaction with the user interface components and associated text. The embodiments are not limited in this context.

The user interface component 122-4 may generally operate to generate a user interface view comprising information elements associated with an annotated document file for presentation on an output device, such as an electronic display. According to an embodiments, the user interface view may be comprised of text elements and corresponding user interface components arranged for presentation on an electronic display. In one embodiment, the user interface components include an audio narration guide located proximate to the text elements. For instance, the text elements may be presented as one or more lines of text and the audio narration guide may be positioned directly beneath each line of text. In another embodiment, user interface component 122-4 may present an audio narration guide comprised of a start indicator corresponding to a start position of the text element, a text sub-element indicator corresponding to a text sub-element of the text element, a sub-element separation indicator corresponding to one or more spaces between text sub-elements of the text element, and an end indicator corresponding to an end position for the text element. The embodiments are not limited in this context.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

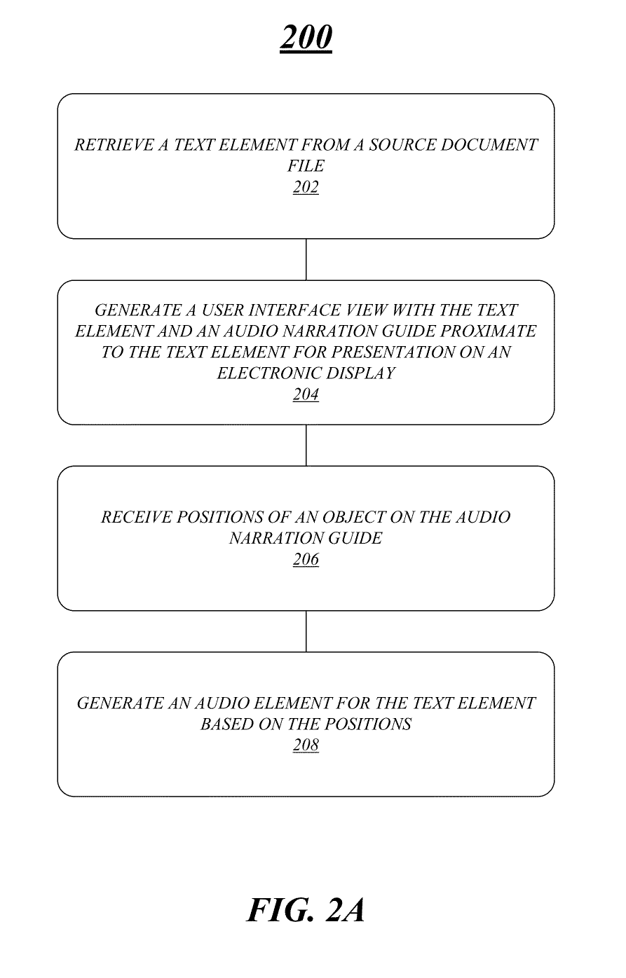

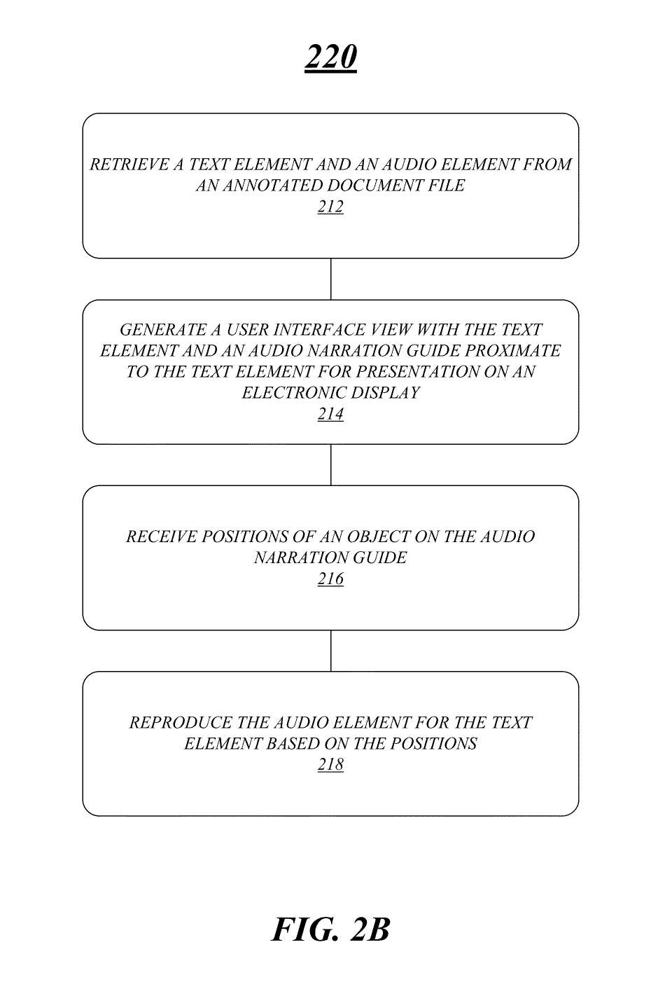

FIG. 2A illustrates one embodiment of a logic flow 200. The logic flow 200 may be representative of some or all of the operations executed by one or more embodiments described herein. For example, the logic flow 200 may illustrate operations performed by the digital document application 112.

In the illustrated embodiment shown in FIG. 2A, the logic flow 200 may retrieve a text element from a source document file at block 202. For example, the document recorder component 122-1 may retrieve text elements from a digital document file accessible by the digital document apparatus 100. According to embodiments, the document recorder component 122-1 may operate to parse a digital document file into text elements, such as pages, paragraphs, sentences, and words, for use within the digital document application 112.

The logic flow 200 may generate a user interface view with the text element and an audio narration guide proximate to the text element for presentation on an electronic display at block 204. For example, the user interface component 122-4 may operate to generate a user interface view comprising text elements retrieved by the document recorder component 122-1. The user interface component 122-4 may present the text elements with audio narration guide user interface components positioned proximate to the corresponding text elements. The user interface view may be presented on an electronic display accessible to the digital document apparatus 100. According to embodiments, the electronic display may be comprised of a touch-screen configured to accept touch-based input.

The logic flow 200 may receive positions of an object on the audio narration guide at block 206. For example, the object position component 122-3 may receive device input communicated to the digital document apparatus 100 by a user. According to embodiments, the device input may include touch-based device input communicated using a touch-screen presenting a user interface. The user interface may be comprised of text elements and user interface components, including an audio narration guide. The object position component 122-3 may operate to interpret, translate, or otherwise detect the device input as indicating a position of an object on the audio narration guide. For a touch-screen input device, the object may comprise a human finger. According to embodiments, the object position component 122-3 may operate to communicate object position information within the digital document application 112, for example, to the document recorder component 122-1.

The logic flow 200 may generate an audio element for the text element based on the positions at block 208. For example, the document recorder component 122-1 may operate to generate an audio element corresponding to a text element associated with the position of input as indicated by the object position component 122-3. According to embodiments, the audio element may be comprised of a recording of an audio narration of a text element by a human voice. The recording may be implemented through a microphone accessible by the digital document apparatus 100 and configured to capture audio narration of the text segment from a human voice to generate the audio element. In one embodiment, the audio element may comprise a single file corresponding to the text element or a portion of a single file corresponding to the text element. The document recorder component 122-1 may generate an annotated document file consisting of text elements retrieved from a source document file and the audio element. The annotated document file may be stored in a memory, for example, the computer readable storage medium 110. In this manner, the digital document application 112 may operate to record audio narration for a digital document according to touch-based input received at the digital document apparatus 100.

FIG. 2B illustrates an embodiment of a logic flow 220. The logic flow 220 may be representative of some or all of the operations executed by one or more embodiments described herein. For example, the logic flow 220 may illustrate operations performed by the digital document application 112.

In the illustrated embodiment shown in FIG. 2B, the logic flow 220 may retrieve a text element and an audio element from an annotated document file at block 212. For example, the document reader component 122-2 may access an annotated document file annotated by the document recorder component 122-1 and retrieve text elements and audio elements contained therein.

The logic flow 220 may generate a user interface view with the text element and an audio narration guide proximate to the text element for presentation on an electronic display at block 214. For example, the user interface component 122-4 may operate to generate a user interface view comprising the text element retrieved by the document reader component 122-2. The text element may be associated with an audio narration guide. The user interface component 122-4 may present the audio narration guide in a location proximate to the text element, such as immediately below the text element. The user interface view generated by the user interface component 122-4 may be presented on an electronic display, for example, a touch-screen, accessible by the digital document apparatus 100.

The logic flow 220 may receive positions of an object on the audio narration guide at block 216. For example, the object position component 122-3 may receive device input communicated to the digital document apparatus 100 through a touch-screen input device. The object position component 122-3 may operate to receive device input indicating a position of an object on the audio narration guide and to communicate the object position information within the digital document application 112, for example, to the document reader component 122-2.

The logic flow 220 may reproduce the audio element for the text element based on the positions at block 218. For example, the document reader component 122-2 may reproduce an audio element for a text element associated with a position on the audio narration guide as received by the object position component 122-3. According to embodiments, reproducing an audio element may comprise playing an audio element corresponding with the text element. In one embodiment, the document reader component 122-2 may reproduce an audio element that comprises an audio narration of the text element by a human voice.

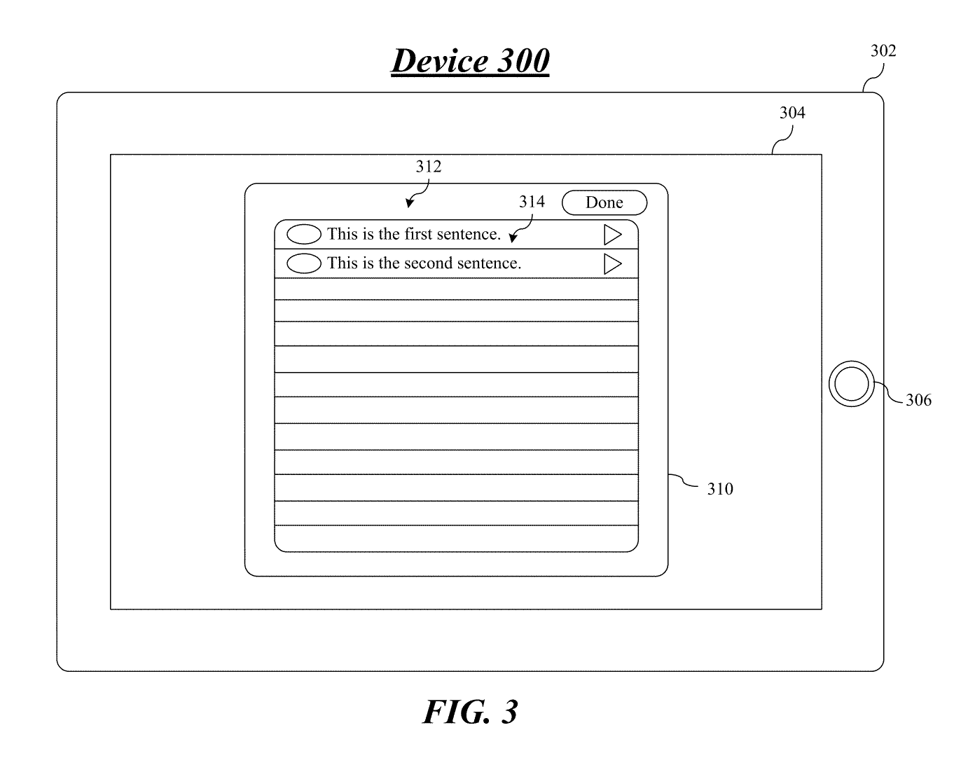

FIG. 3 illustrates an embodiment of a device 300 implementing text element selection. The device 300 may comprise a computing device 302 having an electronic display 304. According to embodiments, the electronic display 304 may be a touch-screen display capable of accepting touch-based input responsive to contact by an object, such as a human finger. The computing device 302 may be configured to house a microphone/speaker 306 operative to capture/transmit a human voice or other audio content. The electronic display 304 may present a text element user interface view 310, for example, as generated by the user interface component 122-4. The text element user interface view 310 illustrated in FIG. 3 presents text elements 312, 314 retrieved from a source document file. For example, the text elements 312, 314 may be retrieved from a source document file by the document recorder component 122-1. In the non-limiting example of FIG. 3, the source document file consists of a first sentence text element 312 and a second sentence text element 314. However, embodiments are not limited to sentence text elements, as the digital document application 112 may operate to parse source document files into any suitable text element, including, but not limited to, pages, paragraphs, words, chapters, sections, syllables, phonemes, speech utterances, or combinations thereof. As such, the digital document application 112 may operate to parse digital documents into text elements 312, 314, which may be individually represented utilizing a text element user interface view 310. The text elements 312, 314 may be individually selected through touch-based input, for example, as part of techniques configured to integrate the text elements 312, 314 with audio elements according to embodiments disclosed herein. For example, a text element 312, 314 may be selected to record synchronized audio for the text element 312, 314.

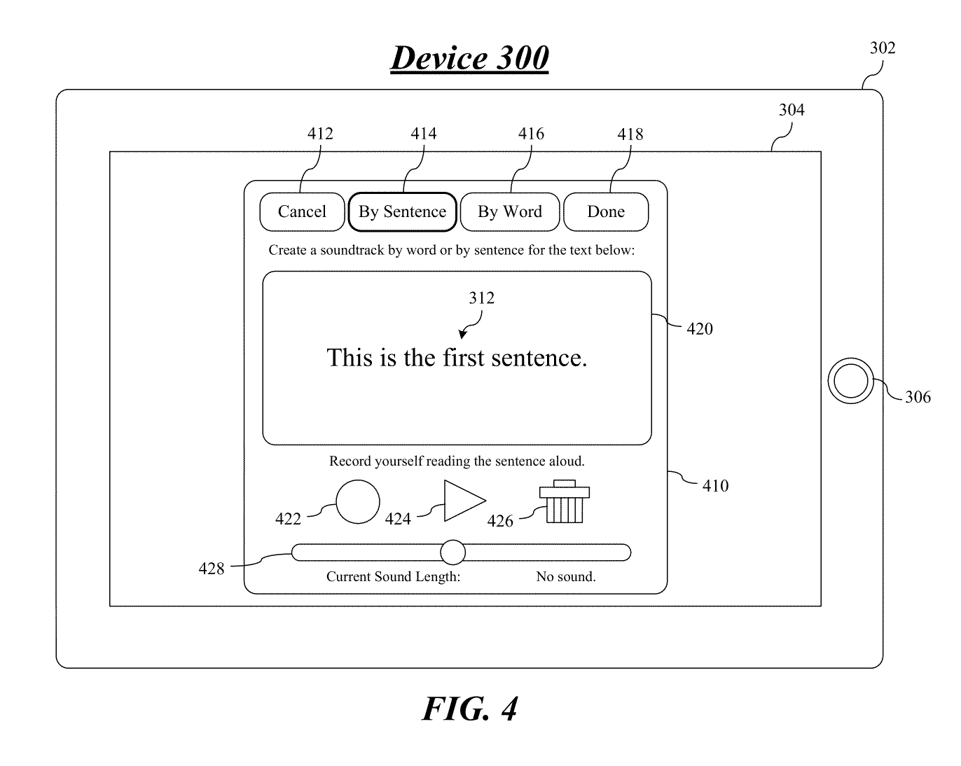

FIG. 4 illustrates an embodiment of the device 300 configured to record synchronized audio elements for a text element at a sentence-level. A recording user interface view 410 is displayed on the electronic display 304 of the computing device 302 depicted in FIG. 4. The recording user interface view 410 may be comprised of various graphical user interface components, such as a text element display 420 configured to display a text element of a current recording event. The recording user interface view 410 may also include virtual buttons configured to perform certain functions or to make certain selections, such as a “Cancel” button 412, a “By Sentence” button 414, a “By Word” button 416, a “Done” button 418, a record button 422, a play button 424, and a delete button 426.

According to embodiments, selection of the By Sentence 414 and By Word 416 buttons may indicate the level of text element for a particular recording event. For example, selection of the By Sentence button 414 may indicate that text elements at a sentence-level will be used for the recording event. Alternatively, selection of the By Word button 416 may indicate that text elements at a word-level will be used for the recording event. Embodiments provide that the distinction between text element levels may operate to determine the granularity of audio elements, for example, whether audio elements may consist of entire sentences or just one word. In the non-limiting example of FIG. 4, the By Sentence button 414 has been selected and the text element 312 that is the focus of the recording event is a sentence text element.

The Cancel button 412 may be configured to cancel a current recording operation, with or without saving any resultant audio element, while the done button 418 may be configured to indicate that the recording event is complete and any resultant audio elements may be saved in an annotated document file. The record 422 and play 424 buttons may be configured as toggle buttons, wherein a first selection places the button 422, 424 in an “on” state, while a subsequent selection places the button 422, 424 in an “off” state. Placing the record button 422 into an on state may start the recording of audio captured by the microphone 306, while placing the record button 422 into an off state may stop the recording of audio. In one embodiment, the starting of recording may be voice activated such that detection of a human voice starts the recording of audio. In addition, if recording has been voice activated, then it may be voice de-activated, wherein the absence of the detection of a human voice (e.g., for a threshold amount of time) may stop the recording of audio. Recorded audio may be played back by placing the play button 424 into an on state, while the play back of recorded audio may be stopped by placing the play button 424 into an off state. Selection of the delete button 426 may operate to delete recorded audio elements, such as one or more audio elements recorded during a recording event. The recording user interface view 410 may also be comprised of a sound length progress bar 428 configured to indicate duration of, and a location within, an audio recording.

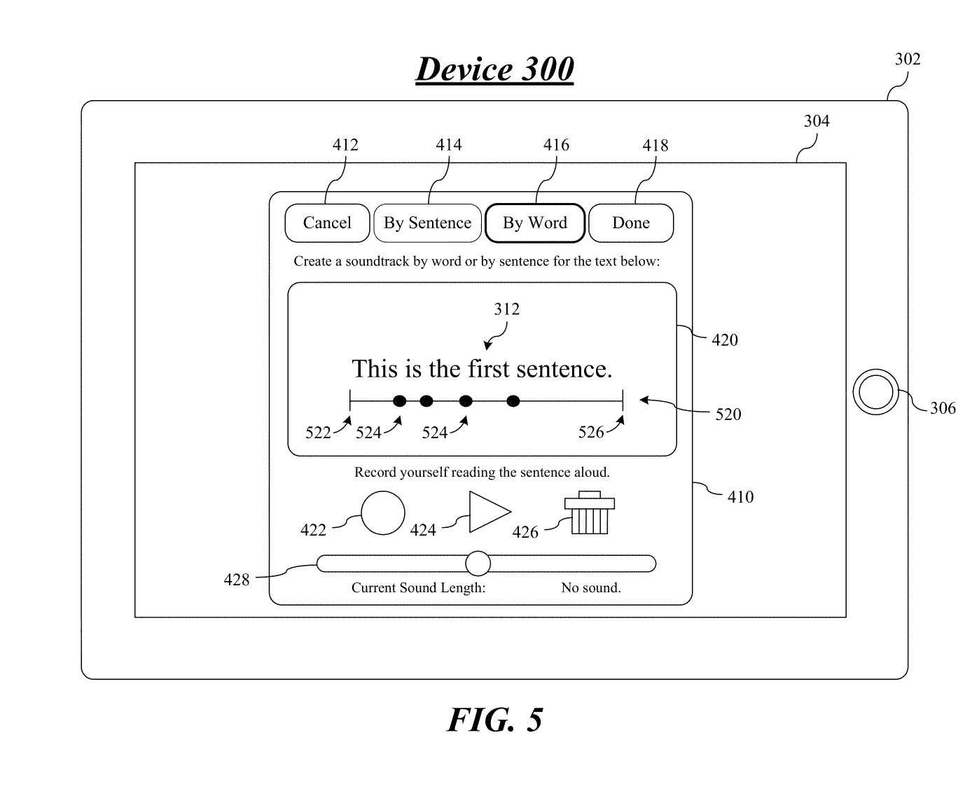

An audio element may be recorded for the text element 312 depicted in FIG. 5. For example, a user may select the record button 422, read the text element 312 aloud, and then select the record button 422 again to stop recording. The audio of the user reading the text element 312 may be captured by the microphone 306, for example, as an audio file or as audio data. When a user selects the Done button 418, the audio element may be associated with the text element. According to embodiments, the document recording component 122-1 may generate an annotated document file comprising the text element 312 and the associated audio element.

FIG. 5 illustrates an embodiment of the device 300 configured to record audio elements for a text element at a word-level facilitated by a word-level user interface component. The text element display 420 depicted in FIG. 5 displays a sentence text element 312 and an audio narration guide 520 configured to facilitate the recording of an audio element for the text element 312 at the word-level. The audio narration guide 520 may be comprised of bar 522, 526 and ball 524 elements arranged along a line. The bar elements 522, 526 may consist of a start indicator 522 corresponding to a start position for the text element 312 and an end indicator 526 corresponding to an end position for the text element 312. The ball elements 524 may be configured as sub-element separation indicators 524 corresponding to one or more spaces between text sub-elements (e.g., words) of the text element 312. According to embodiments, the electronic display 304 may be comprised of a touch-screen input device. As such, a user may gesture along the audio narration guide 520 to indicate a current word during recording of an audio element associated with the text element 312. For example, a user may position a finger at the start indicator 522 when commencing recording to indicate that a word spoken at that time should be associated with the first sub-element of the text element 312 (e.g., “This”). The user may then slide the finger along the audio narration guide 520 to a first sub-element separation indicator 524 positioned between the sub-elements “This” and “is” to indicate that a word spoken at that time should be associated with the next text sub-element (e.g., “is”) of the text element 312. This process may be repeated for all sub-elements that make up the text element 312 until the end indicator 526 is reached indicating that the entire sentence has been read by the user. In this manner, audio elements for each word that make up a sentence text element 312 may be recorded at the word-level by sliding an object along a touch-based graphical user interface component 520 (i.e., an audio narration guide). This process operates, inter alia, to facilitate the efficient recording of audio elements for digital document text based on touch-based input and to support the pacing of the audio element recording according to user interaction with the text element.

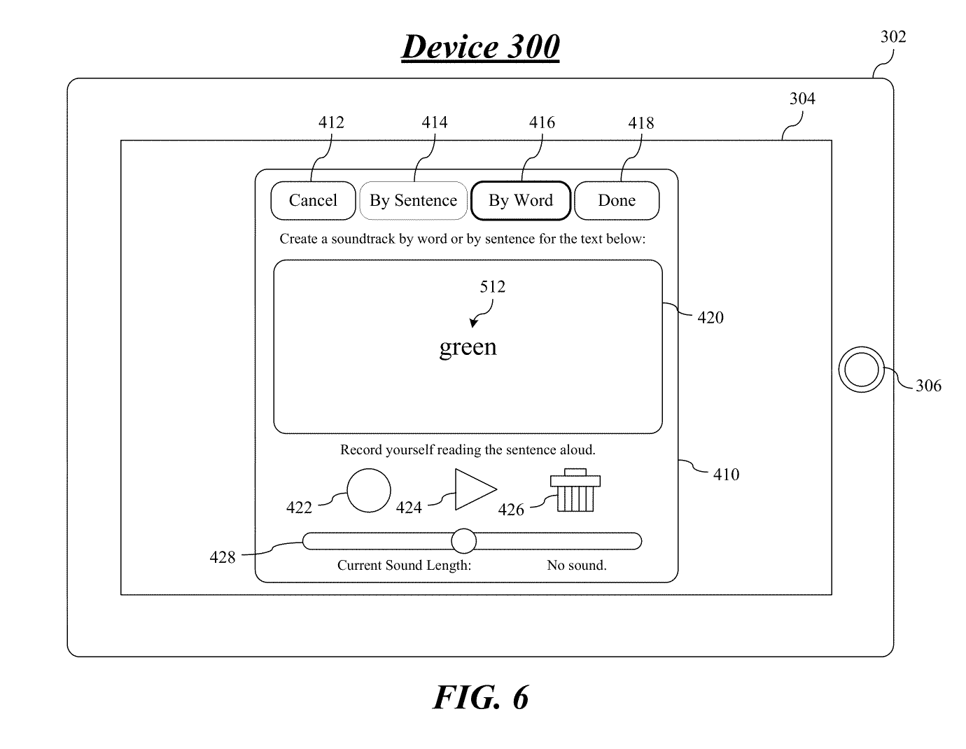

FIG. 6 illustrates an embodiment of the device 300 configured to record audio elements for a text element at a word-level. In the non-limiting example of FIG. 6, the By Word button 416 has been selected and the text element 512 that is the focus of the recording event is a word text element. A user may set the record button 422 to the on state and read the text element 512 aloud. The audio captured by the microphone 306 may be associated with the text element 512, for example, in an annotated document file generated by the document recorder component 122-1.

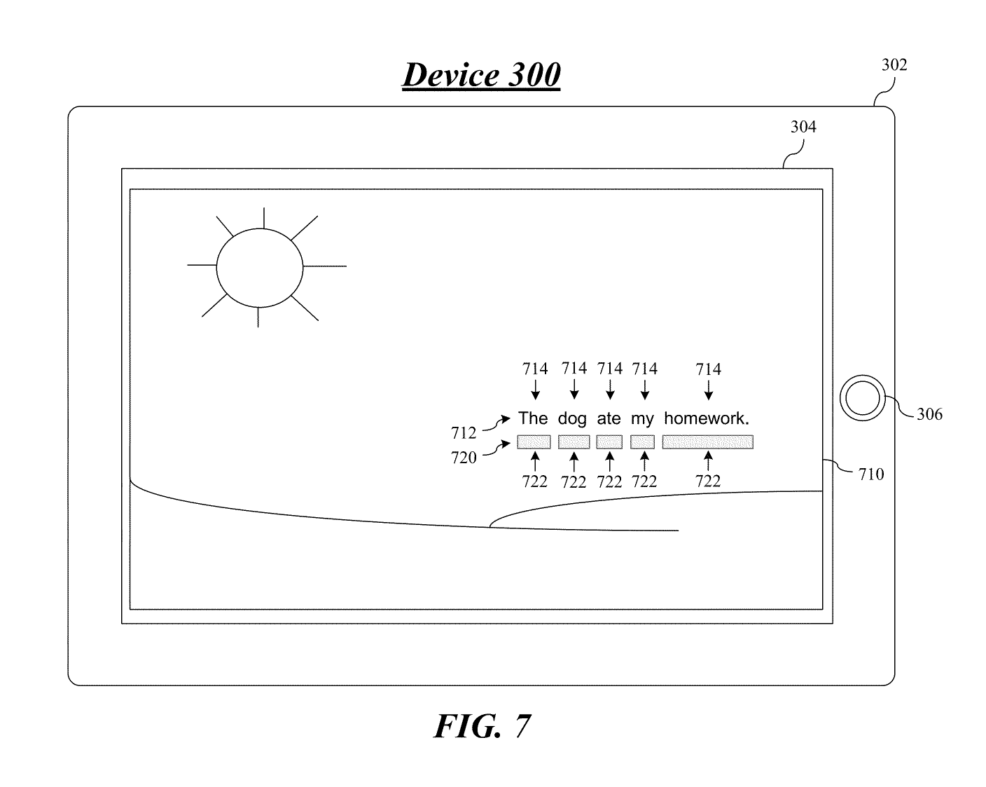

FIG. 7 illustrates an embodiment of the device 300 configured for reading text elements. The electronic display 304 in FIG. 7 presents a reading user interface 710 displaying a text element 712 consisting of multiple sub-elements 714. An audio narration guide 720 may be positioned directly beneath the text element 712. Although not shown in FIG. 7, if a reading user interface 710 displays multiple lines of text, embodiments provide that each line of text may be associated with an audio narration guide positioned directly below the line of text without any intervening line of text. The audio narration guide 720 depicted in FIG. 7 is comprised of multiple text sub-element indicators 722 corresponding to the text sub-elements 714 of the text element 712. A user has multiple options for interacting with the reading user interface 710. For example, a user may read text elements 712 displayed on the reading user interface 710 accompanied or unaccompanied by audio elements. In another example, a user may slide an object, such as a human finger, along the audio narration guide 720 to control the playback of audio elements as they follow the text sub-elements (e.g., words) with their finger. According to embodiments, multiple audio elements may be recorded for each text element 712 according to processes described herein. For instance, a digital document may be associated with more than one audio element in the form of a narrative recording, such as narrative recordings created by a publisher, a teacher, or a student. As such, a user may select which narrative recording to use when reading a text element 712 via the reading user interface 710, for example, through a narrative recording selection element or user interface view. According to embodiments, selection of a text sub-element indicator 722 may be received by the object position component 122-3. In response, the document reading component 122-2 may reproduce the audio element associated with the selected text sub-element indicator 722.

A user may interact with the text element 712 in various ways. For example, a user may select an audio mode wherein an audio element associated with the text element 712 may be reproduced by the document reader component 122-2. In the audio mode, words may be highlighted as the associated audio is played back through the computing device 302. Users may also select an audio and user interface mode wherein the text element 712 may be associated with an audio narration guide 520, 720 such that a user may control the pace of play back of the audio element associated with the text element, for example, by controlling the rate of movement of an object along the audio narration guide 520, 720. In addition, users may select to read without an accompanying audio element, with or without an audio narration guide or text highlighting.

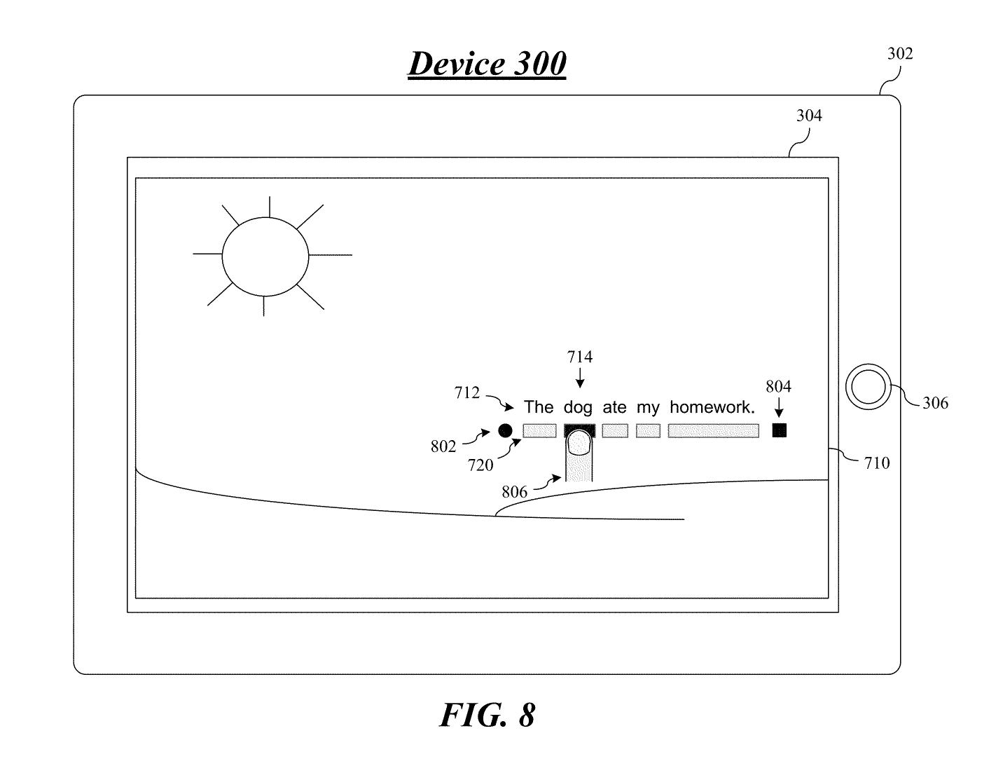

FIG. 8 illustrates an embodiment of the device 300 configured for text level recording from a reading user interface 710 displayed on a touch input capable electronic display 304. As such, embodiments provide that a user may select to interact with text on the reading user interface 710 in a read mode (e.g., FIG. 7), record mode (e.g., FIG. 8), or some combination thereof. A text level recording from a reading user interface 710 may be initiated by pressing a record button 802. A user may indicate the position 806 of the text sub-element 714 (e.g., “dog”) being spoken by touching the corresponding text sub-element indicator 722. Embodiments provide that the position 806 may be highlighted to indicate that the text sub-element 714 is active in the recording process. An audio element generated for an active text sub-element 714 may be associated with the sub-element 714 in an annotated document file. As such, when a user selects the text sub-element 714 (e.g., “dog”) when subsequently reading text elements 712 from a resultant annotated document file, a corresponding audio element will be reproduced. In this manner, the audio elements may be synchronized with the text sub-element 714 being touched at the time of recording. According to embodiments, the beginning and end of touch events (e.g., selection of a text sub-element 714 or entry of an object into an area bounded by a text sub-element 714) may operate as indicators or helpers for inferring start and end times of recorded audio. In one embodiment, speech recognition functions, for example, facilitated by speech recognition software, modules, or plug-ins to the digital document application 112, may operate to improve the accuracy of start and end times of audio elements corresponding to text sub-elements 714. Text level recording may be stopped through selection of a stop button 804 or an extended pause by the speaker.

As demonstrated by FIG. 8, a user may add their own recording to the set of audio elements associated with a particular digital document. For example, a user may open a digital document, such as an annotated document file, on the computing device 302 for display on the reading user interface 710. The user may elect to read the displayed text or may elect to record a text narrative, for example, according to the embodiment depicted in FIGS. 3-6 and 8. According to embodiments, a reading listener function may be implemented through the digital document apparatus 100, digital document application 112, or a combination thereof. For instance, a user may record audio as they read a displayed text element aloud as depicted in FIGS. 3-6 and 8. In this manner, embodiments provide a touch-based interface that allows users to slide an object along the text as they read while a reading listener function “listens” to the spoken audio generated as they read. The recorded audio may be provided to other individuals, for example, teachers, tutors, or parents or accessed at a later time by the user for reading assessment purposes. In one embodiment, the user recorded audio may be processed through speech recognition functions which may operate to identify fluency and words that the user may have read erroneously or otherwise indicated a lack of understanding or familiarity. In another embodiment, the digital document apparatus 100 may access a digital document database and operate to recommend text to a user, for example, to assist in improving reading skills as indicated by the speech recognition processing of their recordings.

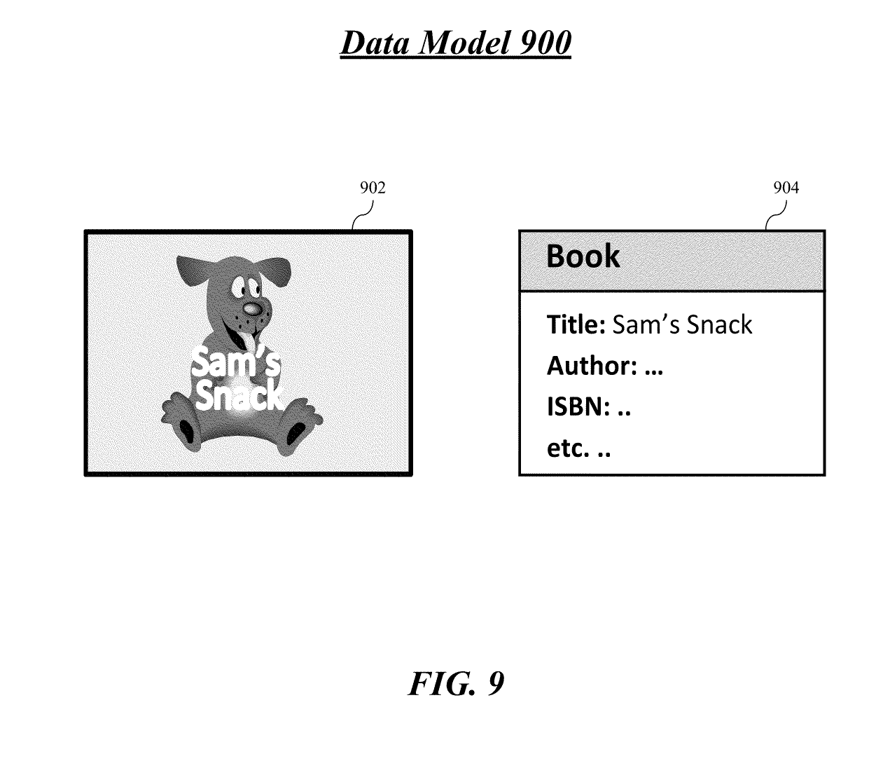

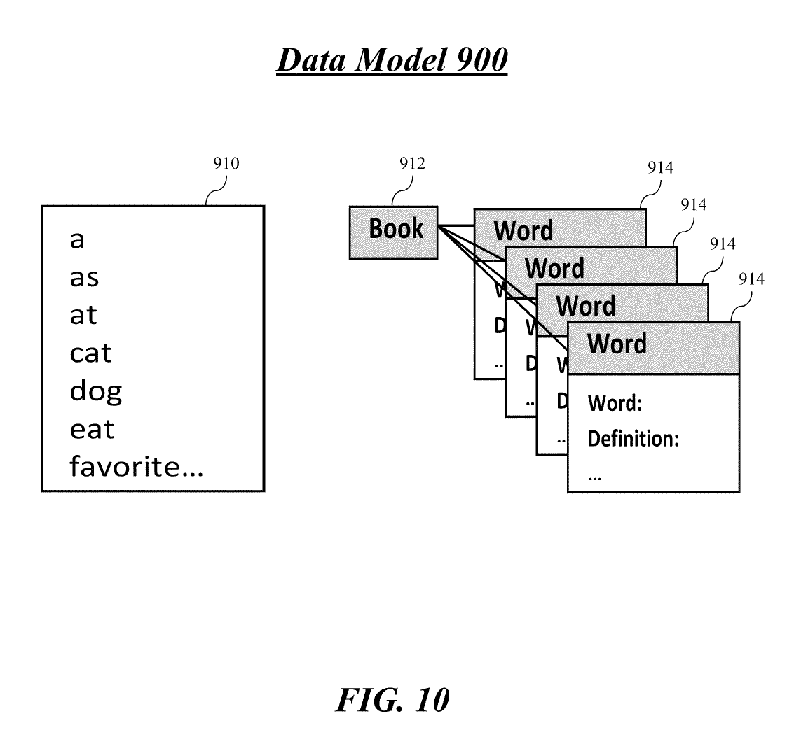

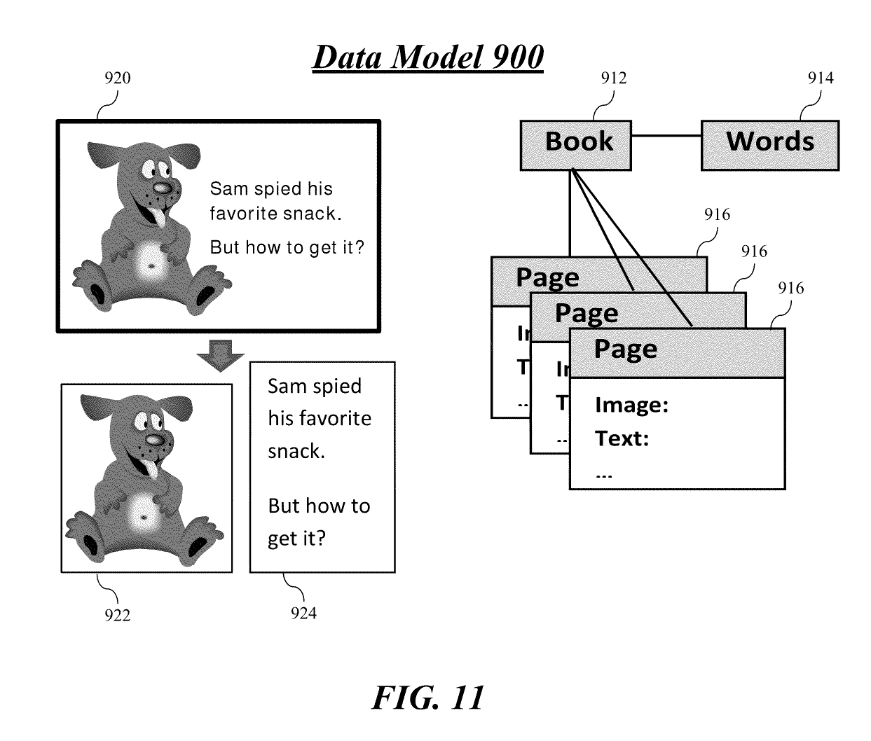

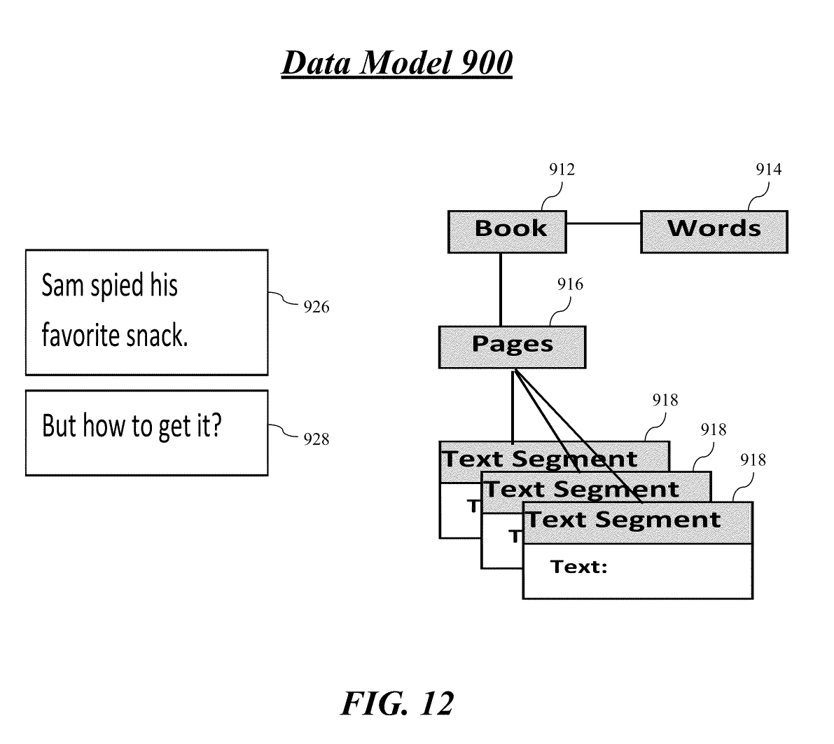

FIGS. 9-12 illustrate example embodiments of data models 900 for a data preparation phase utilized during the processing of digital documents. FIG. 9 illustrates an example digital document 902 comprising text and images in a digital document format according to an embodiment. For instance, the digital document 902 may be in an EPUB® format, such as the EPUB® 3.0 Publications standard provided by the International Digital Publishing Forum. The corresponding data model 904 may be comprised of book information, including the title, author, text, and images. FIG. 10 illustrates an example data preparation phase step involving the creation of a list of all unique words in a book 902 according to an embodiment. The outcome produces a list of all unique words in the book 910 which may be modeled as a book data element 912 related to word data elements 914 for each unique word in the book. According to embodiments, the word data elements 914 may consist of word and word definition information. FIG. 11 illustrates an example data preparation phase step involving the separation of images from text and removing text formatting for each page in a book according to an embodiment. Each digital document page 920 may be separated into image 922 and text 924 components, wherein the text component 924 may consist of the text from the digital document page 920 with text formatting removed. The resulting data model may comprise a book data element 912 related to word data elements 914 and page data elements 916. Embodiments provide that the page data elements 916 may be comprised of image and text information. FIG. 12 illustrates an example data preparation phase step involving the division of text into readable segments according to an embodiment. The outcome of the step illustrated in FIG. 12 may be the parsing of text into readable segments 926, 928. The number and type of readable segments 926, 928 may be dependent on the complexity of the book 902. For example, the readable segments 926, 928 may range from a word, to a sentence, to a full paragraph. In the example embodiment of FIG. 12, the readable segments 926, 928 consist of sentences. The readable segments 926, 928 may be integrated into the data model as text segments 918 being directly related to the page data elements 916.

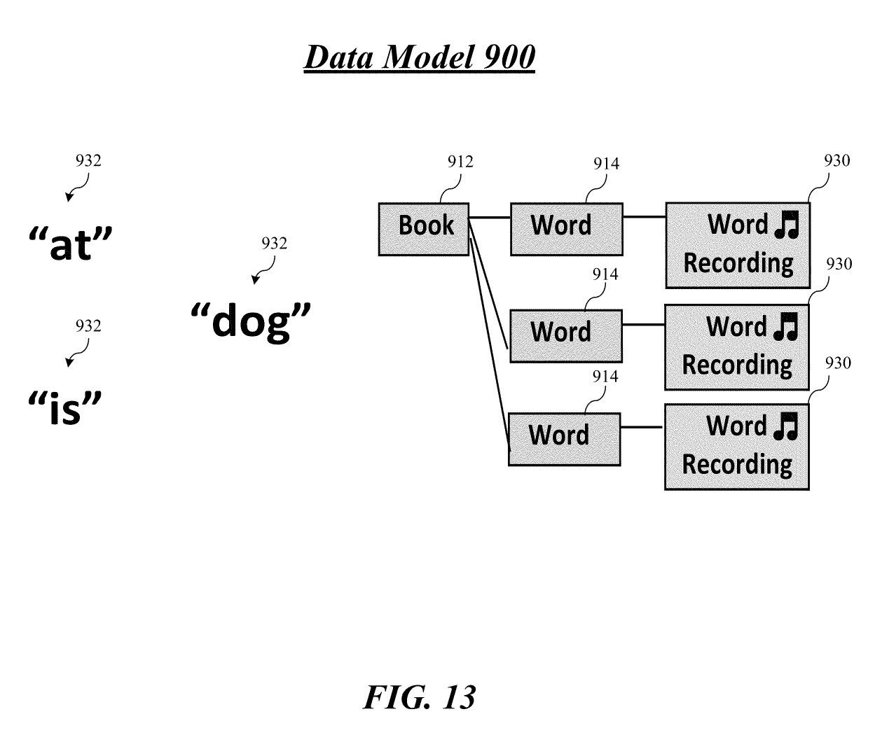

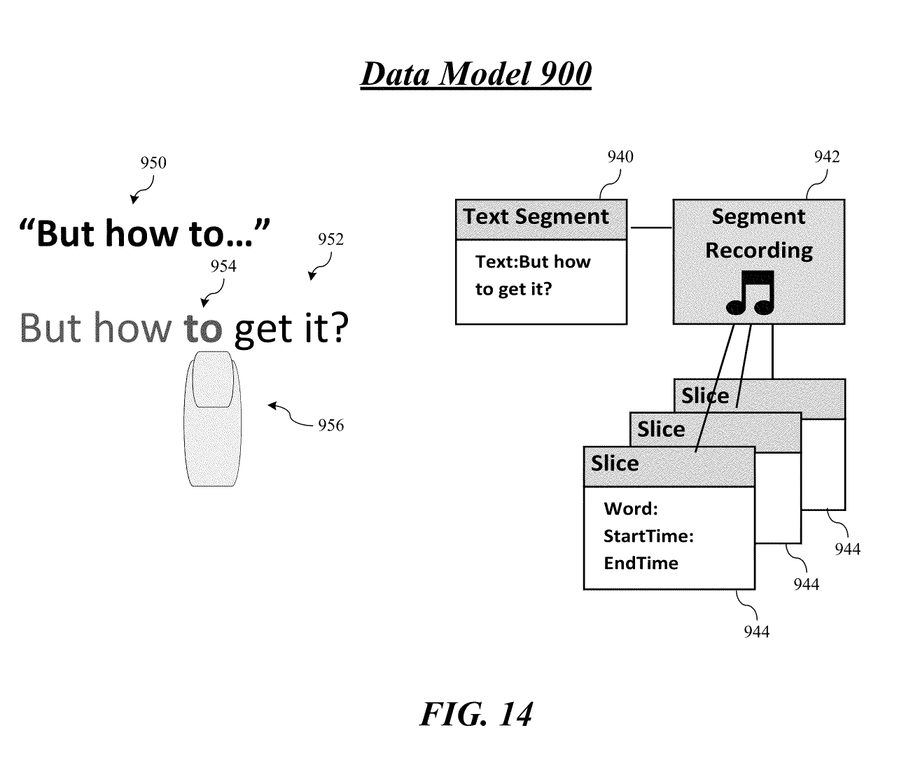

FIGS. 13-14 illustrate example embodiments of data models 900 when gathering recordings associated with a digital document. FIG. 13 illustrates an example embodiment of modeling data for word-level recordings. Audio of a user speaking each unique word 932 may be recorded and saved, for example, in a single audio file. The word-level recordings may be modeled as a book data element 912 comprising word data elements 914 for each unique word in the book 902 which are related to a word recording 930. FIG. 14 illustrates an example embodiment of modeling data for text-level recordings. In the example of FIG. 14, the text-level recordings may consist of sentence-level recordings. For each text segment 950 in a book 902, a user may record themselves speaking the entire segment utilizing a text segment user interface element 952 presented on a user interface according to embodiments disclosed herein. In one embodiment, the user may indicate the word 954 they are speaking by dragging an object 956 below the text segment user interface element 952, for example, making contact with an audio narration guide, as they read. Embodiments provide that a single audio file may be recorded for the entire segment 950, 952. In addition, the time where each word was being spoken may be noted based on user indications made during recording, as described in more detail below. The text-level recording may be modeled as a text segment data element 940 in direct relation with a segment recording 942. The segment recording 942 may be divided into time slices 944 comprising, for example, of word, start time, and end time information.

The data models depicted in FIGS. 9-14 may be utilized to implement various methods of audio element playback. In an autoplay embodiment, play back of an audio element associated with a text element 712 may be initiated by double-tapping on any text sub-element 714 of the text element 712. If available, the segment recording 942 associated with the text element 712 (e.g., contained in a text segment data element 940) may begin playing at a time associated with the start of the text sub-element that was double-tapped. Each text sub-element 714 may be highlighted as it is being played, for example, using the information contained in the time slices 944. In a word assist embodiment, a word assist function may be initiated by a single tap on any text sub-element 714. For instance, if a word-level recording is available for the text sub-element 714, the word-level recording may be played while the text sub-element is highlighted. If no word-level recording is available, the segment recording 942 may be played for the time slice 944 associated with the selected text sub-element 714. In a paced read aloud embodiment, as a reader slides their finger along text sub-elements 714 a word-level recording or the time slice 944 of a segment recording 942 may be played back responsive to the object position contacting a user interface element (e.g., text sub-element indicators) associated with the text sub-element 714.

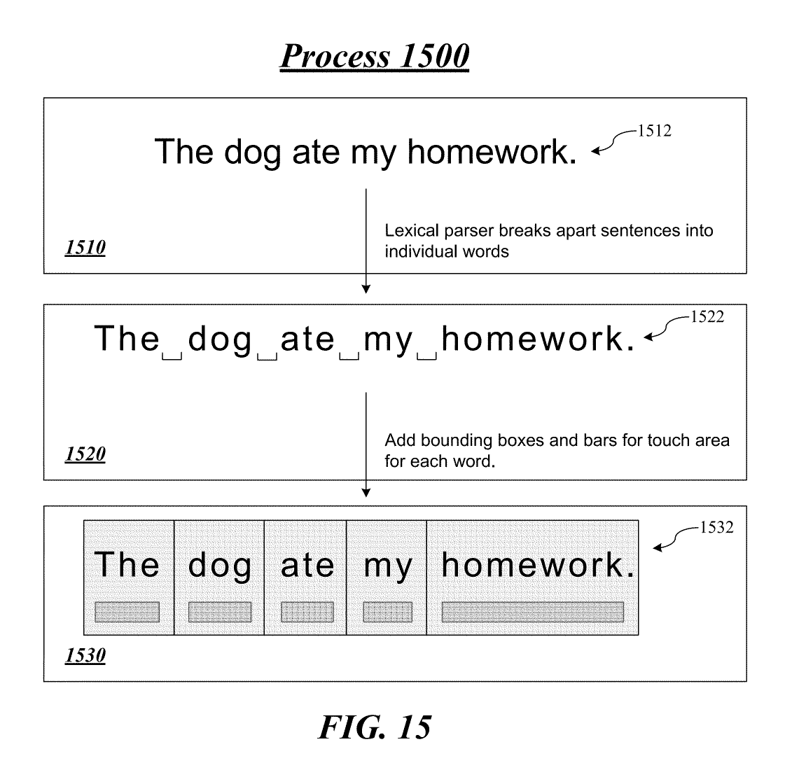

FIG. 15 illustrates an example embodiment of a process 1500 for configuring a touch-based interactive text segment on reading user interface 710. According to embodiments, the document reader component 122-2 may retrieve text elements 1512 from a source document file, such as a file annotated by the document recorder component 122-1. The text element 1512 may be broken down into individual sub-elements 1510, for example, through the use of a lexical parser. In the example of FIG. 15, the text element 1512 comprises a sentence, which may be broken down into word sub-elements. The resulting segmented text element 1512 may consist of words separated by space elements. Bounding boxes and bars defining touch areas for each word may be added 1520 to the text element 1522. The touch-based interactive text element 1532 may be presented on a reading user interface 710 with visible bounding boxes and touch areas (e.g., audio narration guides) that demarcate touchable areas for recording and playback of associated audio elements.

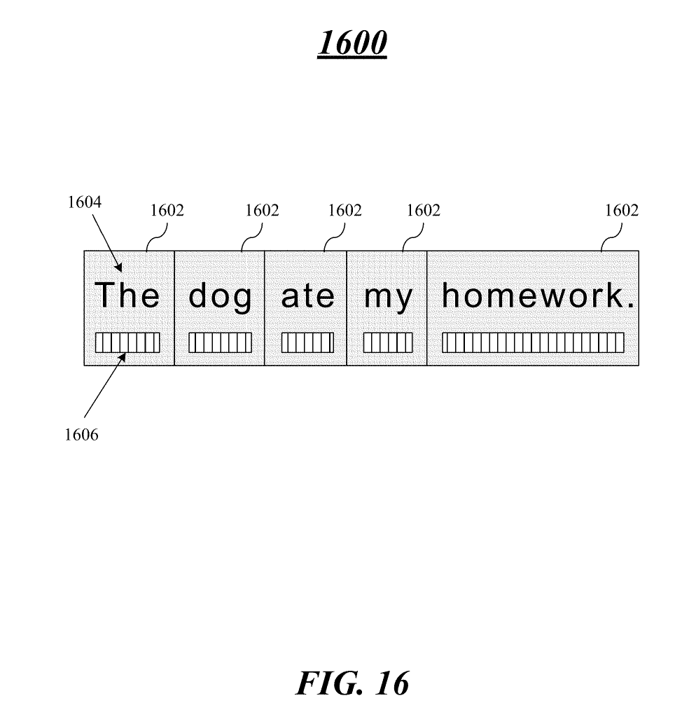

FIG. 16 illustrates an example embodiment of an object contact state 1600 of a touch-based interactive text element 1532. In the example of FIG. 1600, no object contact has been made with the touch-based interactive text element 1532. The touch-based interactive text element 1532 may be comprised of active areas 1602 around each text sub-element 1604 and corresponding audio narration guide portions 1606. Embodiments provide that the active area 1602 may be visible or invisible. In one embodiment, the audio narration guide portions 1606 may be shaded, colored, or otherwise modified to indicate a status of the corresponding text sub-element 1604. For example, a status of a text sub-element 1604 during a play back event may be comprised of “not played,” “played,” “playing,” states as well as word recognition or flagging (e.g., bookmarking) states. In another example, a status of a text sub-element 1604 during a recording event may be comprised of a “not recorded,” “recorded,” or “recording” state. The embodiments are not limited in this context.

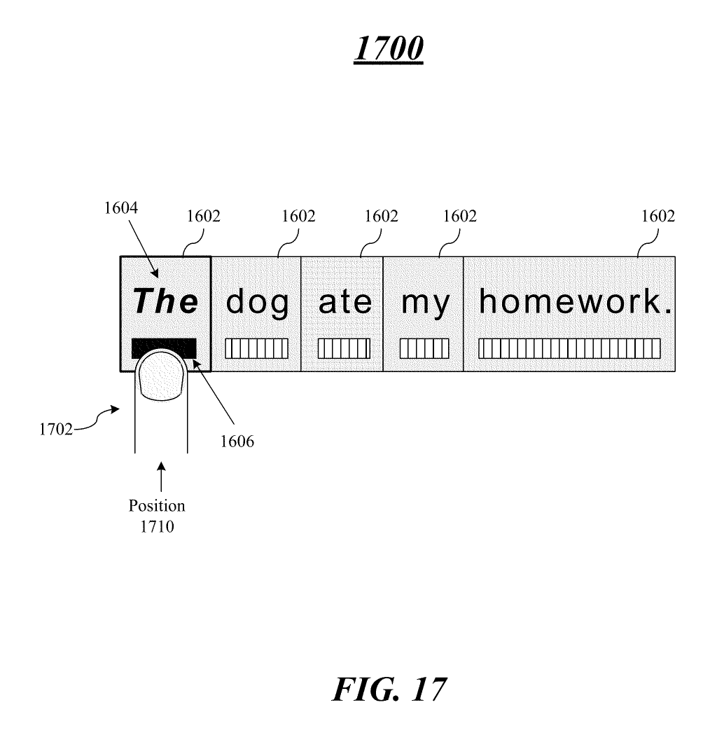

FIG. 17 illustrates another example embodiment of an object contact state 1700 of a touch-based interactive text element 1532. A user may indicate word focus by contacting an audio narration guide portion 1606 with an object 1702, such as a human finger. According to embodiments, the object position component 122-3 may receive the contact as an object position 1710. The contacted audio narration guide portion 1606, text sub-element 1604, active area 1602, or some combination thereof may be highlighted to indicate word focus. Embodiments provide for various object contact events, including, without limitation, tapping, double-tapping, swiping, sliding, or dragging. For example, tapping a text sub-element 1604 may play back audio elements associated with the text sub-element 1604, tapping and holding on text sub-elements 1604 may cause the display of a context menu allowing users to select a particular audio element (e.g., publisher, teacher, student) or to access other information pertaining to the text sub-element 1604 (e.g., dictionary information), while double-tapping anywhere in the touch-based interactive text element 1532 may result in autoplay of all text in the touch-based interactive text element 1532 from the beginning using the current audio element selection.

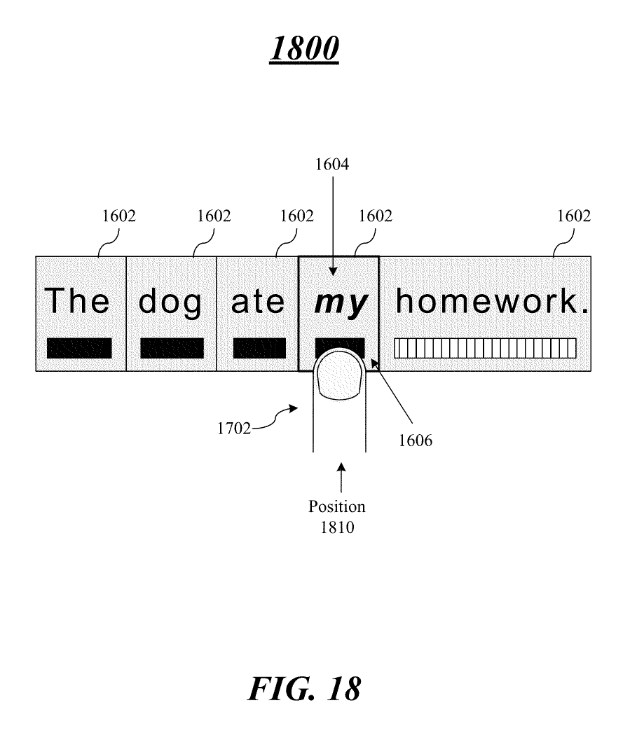

FIG. 18 illustrates another example of an object contact state 1800 of a touch-based interactive text element 1532. In the object contact state 1800, text sub-element 1604 (i.e., “my”) is active as an object 1702 has contacted audio narration guide portion 1606. The object position 1810 is set at the active text sub-element 1604. As shown in FIG. 18, the text sub-elements preceding the active text sub-element 1604 may be highlighted, for example, to indicate that they have already been read. According to embodiments, the object contact state 1800 may be the result of a user sliding their finger along the touch-based interactive text element 1532 as they read each text sub-element.

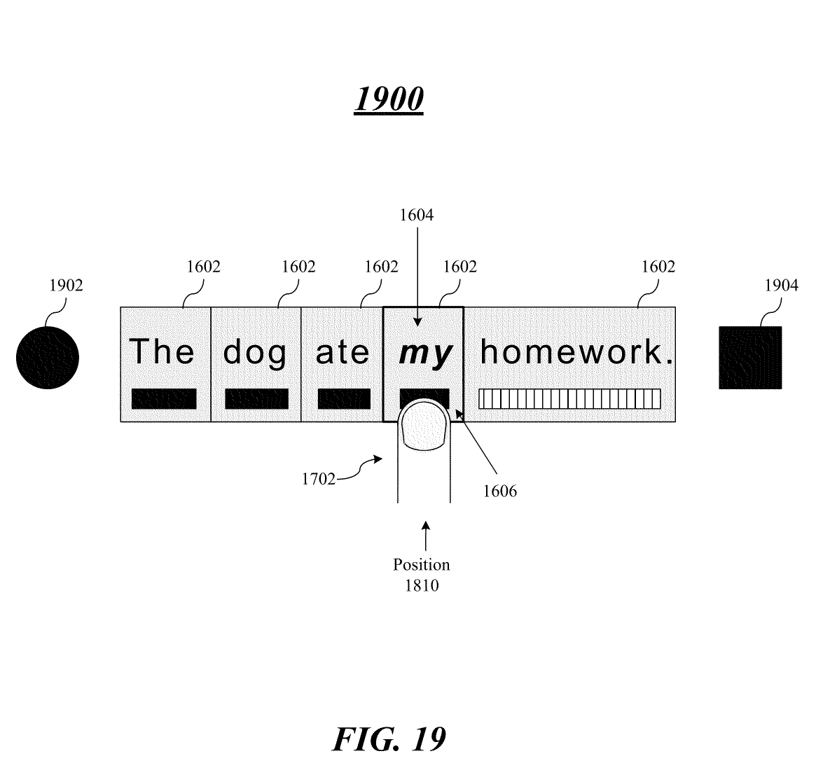

FIG. 19 illustrates an example embodiment of a touch-based interactive text element 1532 configured for text-level recording 1900. As shown in FIG. 19, the touch-based interactive text element 1532 may be associated with record 1902 and stop 1904 buttons. Text level recordings may be initiated by pressing the record button 1904. A user may indicate which word they are speaking by contacting the active area 1602 of the desired word, for example, by touching the audio narration guide portion 1606 contained within the active area 1602. The word may be highlighted as previously described to indicate a recording state. The document recorder component 122-1 may utilize the position 1810 during the record event to generate an audio element for the active text sub-element 1604. The text level recording may be stopped by pressing the stop button 1902. In the text-level recording 1900 depicted in FIG. 19, a user may select each word by sliding their finger along the touch-based interactive text element 1532 contacting audio narration guide portions. In this manner, a user may record audio narration for a segment of text by starting the recording process, moving their finger along the segment of text as they read aloud, and stopping the recording process when finished.

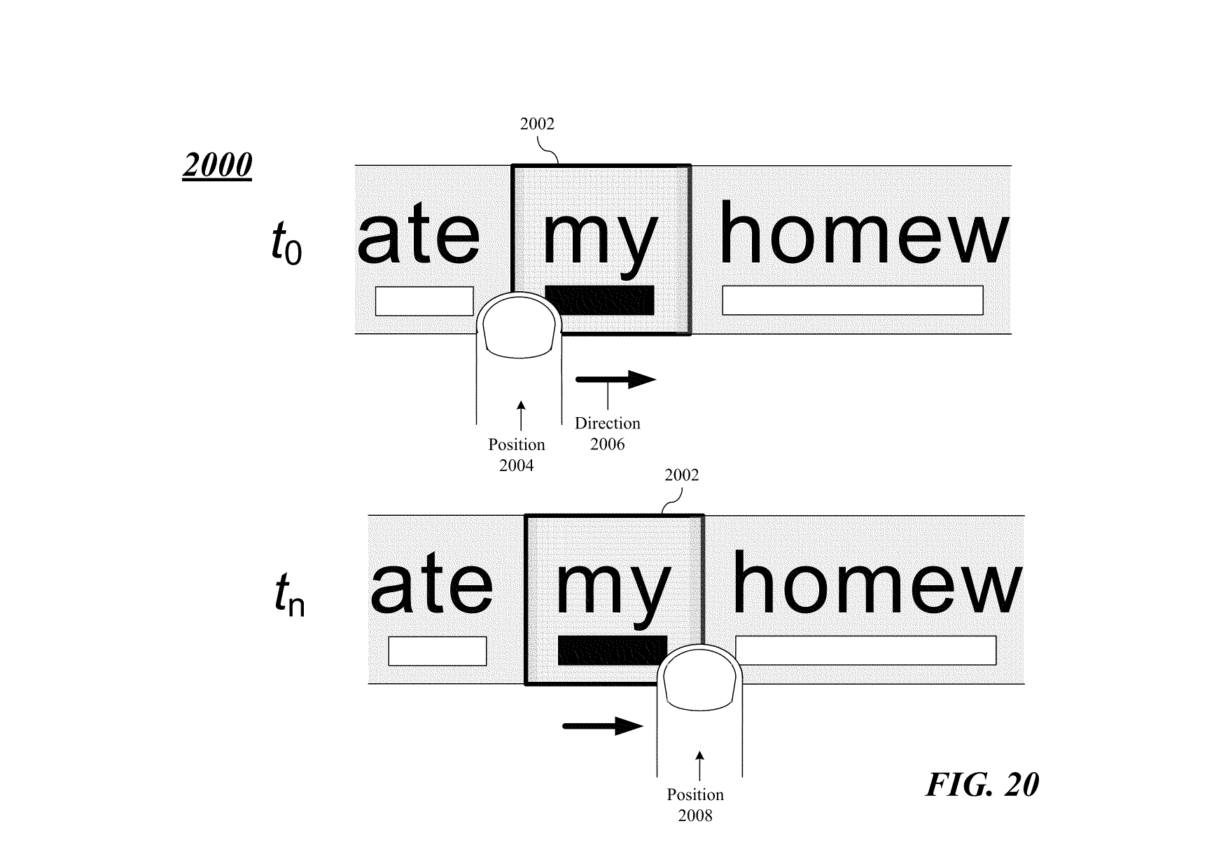

FIG. 20 illustrates an example embodiment of touch-based timing 2000 of audio element recordings. Embodiments provide that the beginning and end of touch events may be utilized as indicators or helpers to infer start times of corresponding audio, for example, by the document recorder component 122-1. As shown in FIG. 20, a user may contact an active area 2002 of a text sub-element 714 at position 2004 at time t₀, with the contact having a direction 2006. For example, user contact may comprise sliding a finger in a right-to-left direction across the active area 2002. According to embodiments, a start touch event for a text sub-element 714 may be generated when the object 1702 enters an active area 2002 for the text sub-element 714, such as at position 2004. At time tₙ, the user contact may be located at position 2008 as the object is moved right-to-left direction across the active area 2002. A stop touch event for a text sub-element 714 may be generated responsive to the position 2008 of the object 702 exiting an active area 2002 of the text sub-element 714. Object contact at positions 2004 and 2008 may be used to indicate a start time t₀ and an end time tₙ, respectively, of the audio element associated with the text sub-element 714 contained within the active area 2002. In one embodiment, the touch-based timing information (e.g., active area 2002, positions 2004, 2008, and times t₀ and tₙ) may be included in annotated document files generated by the document recorder component 122-1. For example, embodiments provide that the touch-based timing information may be used to synchronize audio elements with corresponding text.

According to embodiments, the start time t₀ may be stored responsive to a start touch event, and the stop time tₙ may be stored responsive to a stop touch event. In one embodiment, start and stop touch events may be used to start and stop the reproduction of audio elements. For example, reproduction of an audio element for an audio sub-element (e.g., a word-level audio sub-element for a sentence-level audio element) corresponding to a text sub-element at a start time associated with the audio sub-element may be initiated by a start event for the text sub-element. Conversely, stop touch events may similarly be used to stop reproduction of an audio element associated with a text sub-element.

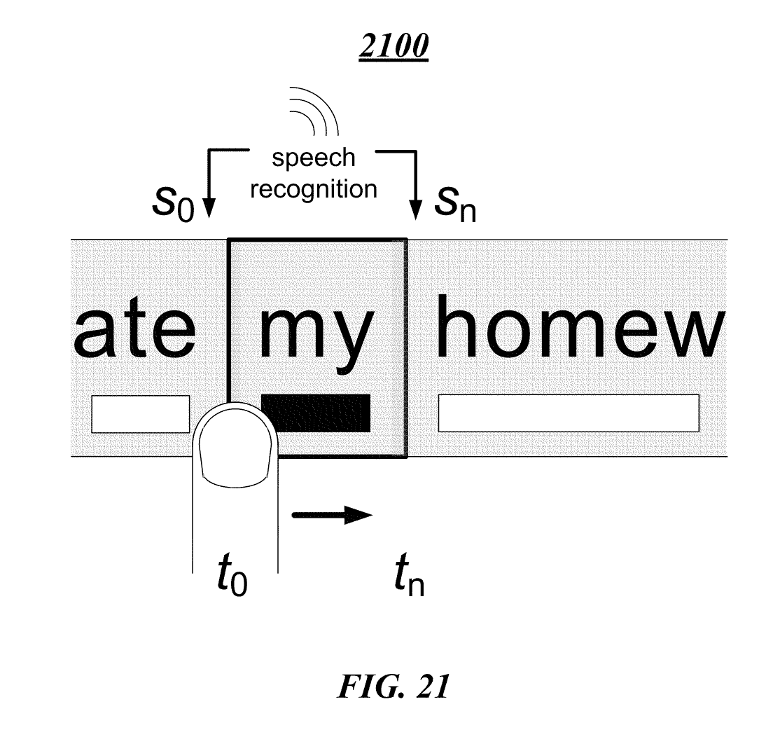

FIG. 21 illustrates an example embodiment of touch-based speech recognition listening 2100. The start time t₀ and end time tₙ for each word may be further refined using speech recognition functions. According to embodiments, the touch times t₀, tₙ, may operate as approximations that may allow speech recognition functions to more accurately identify the beginning and end of words for audio element generation and play back. As shown in FIG. 21, the time span of t₀-tₙ may be accompanied by a speech recognition span starting at s₀ corresponding with t₀ and ending with sₙ corresponding with tₙ. Speech recognition functions may operate during the s₀-sₙ span to refine audio element beginning and end points to provide more accurate recordings. The speech recognition functions may be provided by a software application, module, plug-in, or similar software construct accessible by the digital document application 112.

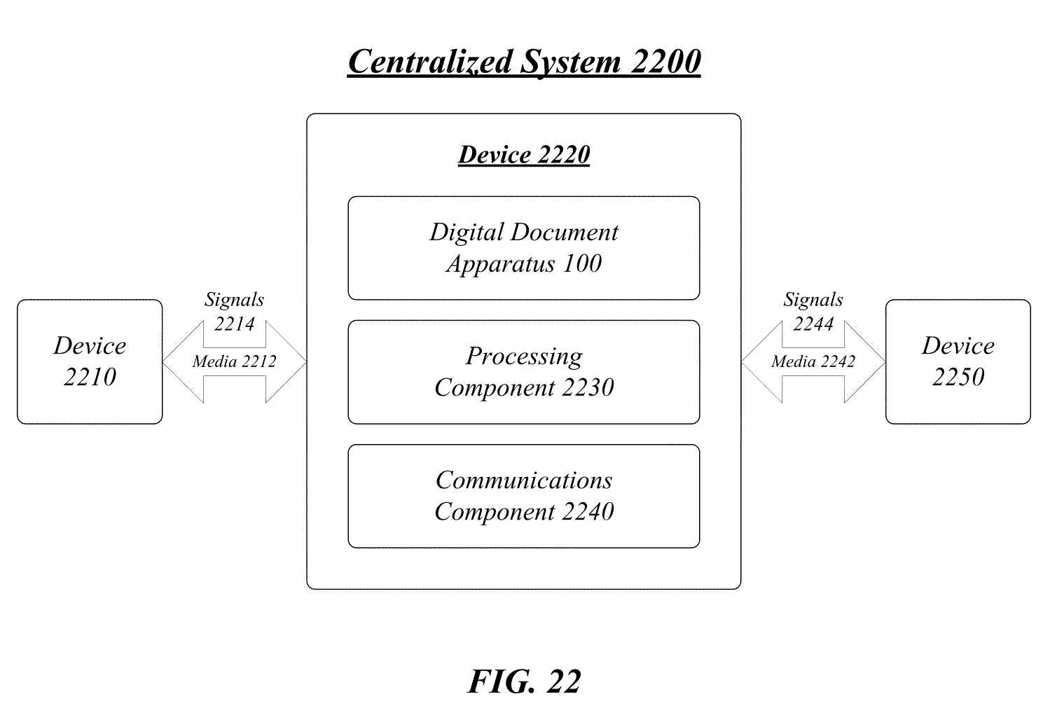

FIG. 22 illustrates a block diagram of a centralized system 2200. The centralized system 2200 may implement some or all of the structure and/or operations for one or more of the components of the digital document apparatus 100, such as the computing device 302, in a single computing entity, such as entirely within a single device 2220.

The device 2220 may comprise any electronic device capable of receiving, processing, and sending information for the digital document apparatus 100. Examples of an electronic device may include without limitation an ultra-mobile device, a mobile device, a personal digital assistant (PDA), a mobile computing device, a smart phone, a telephone, a digital telephone, a cellular telephone, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The device 2220 may execute processing operations or logic for the digital document apparatus 100 using a processing component 2230. The processing component 2230 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 2220 may execute communications operations or logic for the digital document apparatus 100 using communications component 2240. The communications component 2240 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 2240 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 2212, 2242 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. In one embodiment, for example, the communications component 2240 may comprise a wireless transceiver to communicate radio frequency (RF) electromagnetic signals representing the annotated document file to a reader system, such as computing device 302.

The device 2220 may communicate with other devices 2210, 2250 over a communications media 2212, 2242, respectively, using communications signals 2214, 2244, respectively, via the communications component 2240. The devices 2210, 2250 may be internal or external to the device 2220 as desired for a given implementation. For example, the devices 2210, 2250 may include servers, routers, or other components in a network that links the client device 302 to databases or other sources of electronic information. The embodiments are not limited in this context.

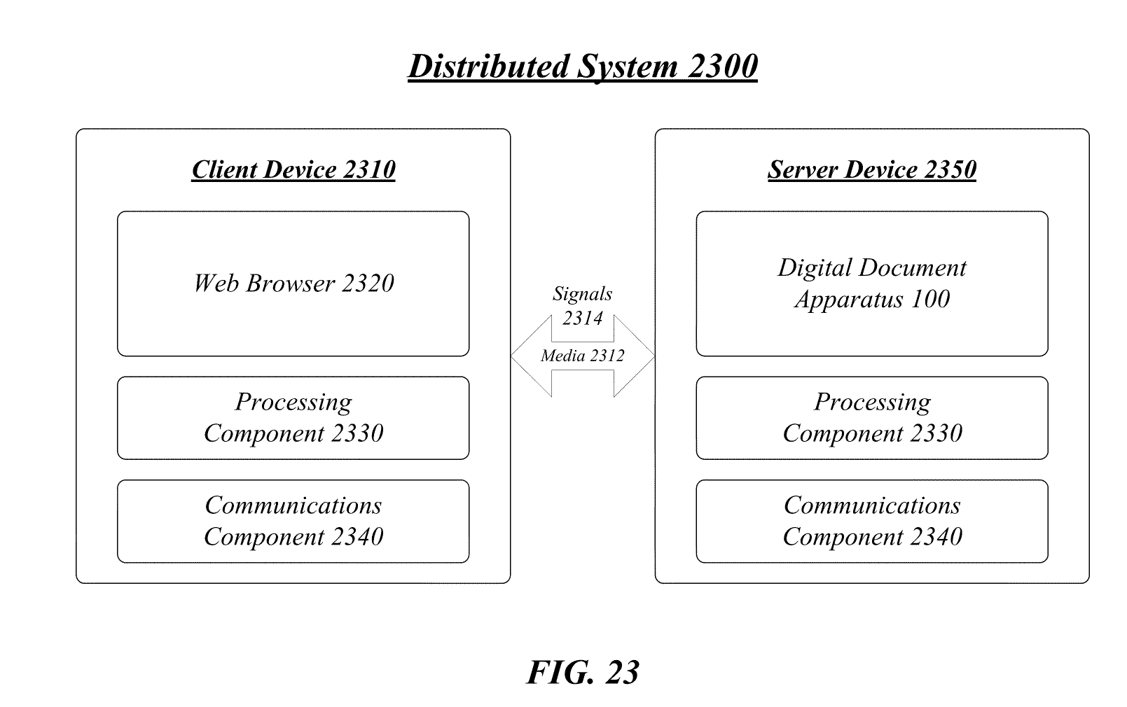

FIG. 23 illustrates a block diagram of a distributed system 2300. The distributed system 2300 may distribute portions of the structure and/or operations for the digital document apparatus 100 across multiple computing entities. Examples of distributed system 2300 may include without limitation a client-server architecture, a S-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 2300 may comprise a client device 2310 and a server device 2350. In general, the client device 2310 may be the same or similar to the client device 2220 as described with reference to FIG. 22. In various embodiments, the client system 2310 and the server system 2350 may each comprise a processing component 2330 and a communications component 2340 which are the same or similar to the processing component 2230 and the communications component 2240, respectively, as described with reference to FIG. 22. In another example, the devices 2310, 2350 may communicate over a communications media 2312 using communications signals 2314 via the communications components 2340.

The client device 2310 may comprise or employ one or more client applications that operate to perform various methodologies in accordance with the described embodiments, for example, the client device 2310 may implement a web browser 2320. In one embodiment, the client device 2310 may access digital documents, such as annotated document files, from the web browser 2320.

The server device 2350 may comprise or employ one or more server programs that operate to perform various methodologies in accordance with the described embodiments. In one embodiment, for example, the server device 2350 may implement the digital document apparatus 100 according to embodiments provided herein. For example, the digital document apparatus 100 may be implemented to provide access to annotated document files to a client device 2310.

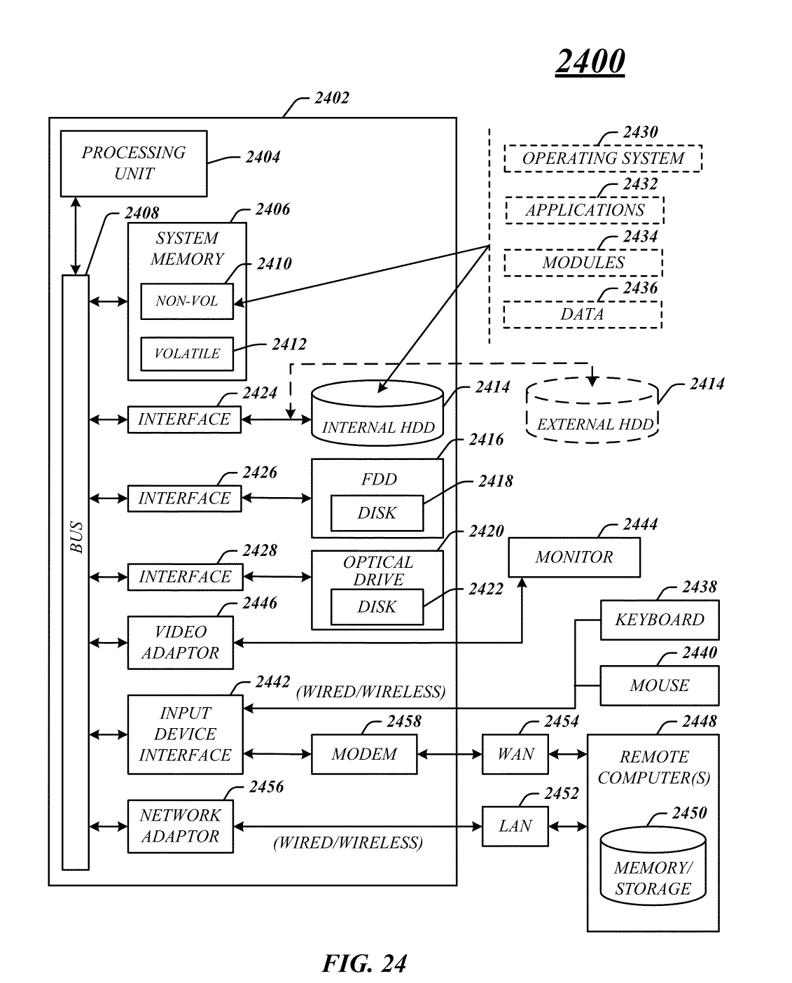

FIG. 24 illustrates an embodiment of an exemplary computing architecture 2400 suitable for implementing various embodiments as previously described. In one embodiment, the computing architecture 2400 may comprise or be implemented as part of an electronic device. Examples of an electronic device may include those described with reference to FIG. 22, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 2400. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 2400 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 2400.

As shown in FIG. 24, the computing architecture 2400 comprises a processing unit 2404, a system memory 2406 and a system bus 2408. The processing unit 2404 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 2404.

The system bus 2408 provides an interface for system components including, but not limited to, the system memory 2406 to the processing unit 2404. The system bus 2408 can be any of several types of bus structure that may further interconnect to a memory bus (with or without a memory controller), a peripheral bus, and a local bus using any of a variety of commercially available bus architectures. Interface adapters may connect to the system bus 2408 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 2400 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 2406 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 24, the system memory 2406 can include non-volatile memory 2410 and/or volatile memory 2412. A basic input/output system (BIOS) can be stored in the non-volatile memory 2410.

The computer 2402 may include various types of computer-readable storage media in the form of one or more lower speed memory units, including an internal (or external) hard disk drive (HDD) 2414, a magnetic floppy disk drive (FDD) 2416 to read from or write to a removable magnetic disk 2418, and an optical disk drive 2420 to read from or write to a removable optical disk 2422 (e.g., a CD-ROM or DVD). The HDD 2414, FDD 2416 and optical disk drive 2420 can be connected to the system bus 2408 by a HDD interface 2424, an FDD interface 2426 and an optical drive interface 2428, respectively. The HDD interface 2424 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 2410, 2412, including an operating system 2430, one or more application programs 2432, other program modules 2434, and program data 2436. In one embodiment, the one or more application programs 2432, other program modules 2434, and program data 2436 can include, for example, the various applications and/or components of the digital document apparatus 100.

A user can enter commands and information into the computer 2402 through one or more wire/wireless input devices, for example, a keyboard 2438 and a pointing device, such as a mouse 2440. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch-screens (e.g., capacitive, resistive, etc.), trackballs, trackpads, sensors, styluses, and the like. These and other input devices are often connected to the processing unit 2404 through an input device interface 2442 that is coupled to the system bus 2408, but can be connected by other interfaces such as a parallel port, IEEE 1394 serial port, a game port, a USB port, an IR interface, and so forth.

A monitor 2444 or other type of display device is also connected to the system bus 2408 via an interface, such as a video adaptor 2446. The monitor 2444 may be internal or external to the computer 2402. In addition to the monitor 2444, a computer typically includes other peripheral output devices, such as speakers, printers, and so forth.

The computer 2402 may operate in a networked environment using logical connections via wire and/or wireless communications to one or more remote computers, such as a remote computer 2448. The remote computer 2448 can be a workstation, a server computer, a router, a personal computer, portable computer, microprocessor-based entertainment appliance, a peer device or other common network node, and typically includes many or all of the elements described relative to the computer 2402, although, for purposes of brevity, only a memory/storage device 2450 is illustrated. The logical connections depicted include wire/wireless connectivity to a local area network (LAN) 2452 and/or larger networks, for example, a wide area network (WAN) 2454. Such LAN and WAN networking environments are commonplace in offices and companies, and facilitate enterprise-wide computer networks, such as intranets, all of which may connect to a global communications network, for example, the Internet.

When used in a LAN networking environment, the computer 2402 is connected to the LAN 2452 through a wire and/or wireless communication network interface or adaptor 2456. The adaptor 2456 can facilitate wire and/or wireless communications to the LAN 2452, which may also include a wireless access point disposed thereon for communicating with the wireless functionality of the adaptor 2456.

When used in a WAN networking environment, the computer 2402 can include a modem 2458, or is connected to a communications server on the WAN 2454, or has other means for establishing communications over the WAN 2454, such as by way of the Internet. The modem 2458, which can be internal or external and a wire and/or wireless device, connects to the system bus 2408 via the input device interface 2442. In a networked environment, program modules depicted relative to the computer 2402, or portions thereof, can be stored in the remote memory/storage device 2450. It will be appreciated that the network connections shown are exemplary and other means of establishing a communications link between the computers can be used.

The computer 2402 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

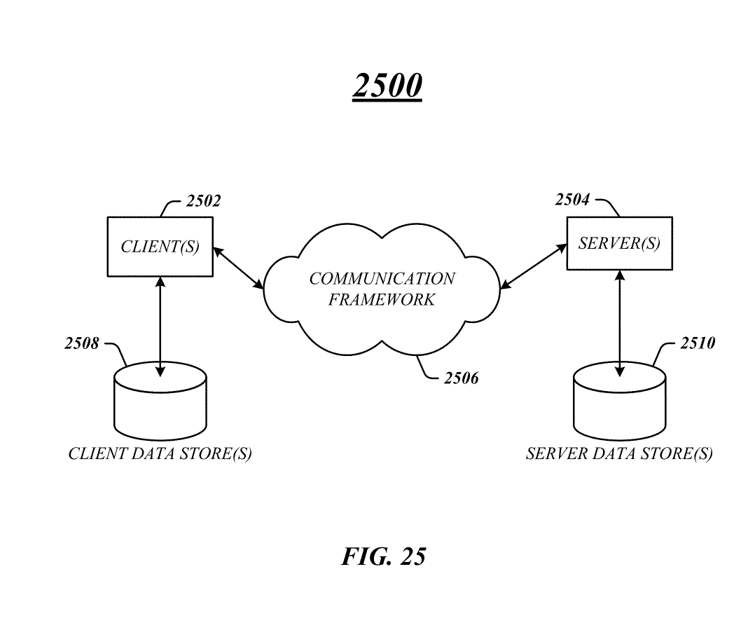

FIG. 25 illustrates a block diagram of an exemplary communications architecture 2500 suitable for implementing various embodiments as previously described. The communications architecture 2500 includes various common communications elements, such as a transmitter, receiver, transceiver, radio, network interface, baseband processor, antenna, amplifiers, filters, power supplies, and so forth. The embodiments, however, are not limited to implementation by the communications architecture 2500.

As shown in FIG. 25, the communications architecture 2500 comprises includes one or more clients 2502 and servers 2504. The clients 2502 may implement the client device 2310. The servers 2504 may implement the server device 950. The clients 2502 and the servers 2504 are operatively connected to one or more respective client data stores 2508 and server data stores 2510 that can be employed to store information local to the respective clients 2502 and servers 2504, such as cookies and/or associated contextual information.

The clients 2502 and the servers 2504 may communicate information between each other using a communication framework 2506. The communications framework 2506 may implement any well-known communications techniques and protocols. The communications framework 2506 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 2506 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 2502 and the servers 2504. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A computer-implemented method, comprising:
retrieving a text element from a source document file;
generating a user interface view with the text element and an audio narration guide proximate to the text element for presentation on an electronic display;
receiving positions of an object on the audio narration guide; and
generating an audio element for the text element based on the positions.

2. The computer-implemented method of claim 1, comprising retrieving a text element from the source document file comprising a word, sentence, paragraph or page of a document.

3. The computer-implemented method of claim 1, comprising generating the user interface view with the text element presented as one or more lines of text on the user interface view, and the audio narration guide positioned directly beneath each line of text.

4. The computer-implemented method of claim 1, comprising generating a user interface view with the text element and the audio narration guide proximate to the text element, the audio narration guide comprising a start indicator corresponding to a start position for the text element, a text sub-element indicator corresponding to a text sub-element of the text element, a sub-element separation indicator corresponding to one or more spaces between text sub-elements of the text element, and an end indicator corresponding to an end position for the text element.

5. The computer-implemented method of claim 1, comprising defining a visible active area around each text sub-element of the text element and a corresponding portion of the audio narration guide.

6. The computer-implemented method of claim 1, comprising defining an invisible active area around each text sub-element of the text element and a corresponding portion of the audio narration guide.

7. The computer-implemented method of claim 1, comprising receiving positions of the object on the audio narration guide from a touch-screen display.

8. The computer-implemented method of claim 1, comprising generating a start touch event for a text sub-element of the text element when a position of the object enters an active area for the text sub-element.

9. The computer-implemented method of claim 1, comprising generating a stop touch event for a text sub-element of the text element when a position of the object exits an active area of the text sub-element.

10. The computer-implemented method of claim 1, comprising synchronizing the audio element and the text element.

11. The computer-implemented method of claim 1, comprising starting a recording of an audio narration of the text element by a human voice to begin generation of the audio element.

12. The computer-implemented method of claim 1, comprising storing a start time for an audio sub-element of the audio element corresponding to a text sub-element of the text element based on a start touch event for the text sub-element.

13. The computer-implemented method of claim 1, comprising storing an end time for an audio sub-element of the audio element corresponding to a text sub-element of the text element based on a stop touch event for the text sub-element.

14. The computer-implemented method of claim 1, comprising refining a start time and an end time for an audio sub-element of the audio element corresponding to a text sub-element of the text element based on a start touch event and a stop touch event, respectively, for the text sub-element using a speech recognition algorithm.

15. The computer-implemented method of claim 1, comprising stopping a recording of an audio narration of the text element by a human voice to end generation of the audio element.

16. The computer-implemented method of claim 1, comprising storing the text element and the audio element in an annotated document file having a defined data format associated with a reader system.

17. At least one computer-readable storage medium comprising instructions that, when executed, cause a system to:
retrieve a text element from a source document file;
generate a user interface view with the text element and an audio narration guide within a defined distance of the text element;
receive positions of an object on the audio narration guide;
generate an audio element for the text element based on the positions; and
synchronize the audio element and the text element.

18. The computer-readable storage medium of claim 17, comprising instructions that when executed cause the system to generate the user interface view with the text element presented as one or more lines of text on the user interface view, and the audio narration guide positioned directly beneath each line of text without any intervening line of text.

19. The computer-readable storage medium of claim 17, comprising instructions that when executed cause the system to generate a user interface view with the text element and the audio narration guide proximate to the text element, the audio narration guide comprising a start indicator corresponding to a start position for the text element, a text sub-element indicator corresponding to a text sub-element of the text element, a sub-element separation indicator corresponding to one or more spaces between text sub-elements of the text element, and an end indicator corresponding to an end position for the text element.

20. The computer-readable storage medium of claim 17, comprising instructions that when executed cause the system to defining an active area around each text sub-element of the text element and a corresponding portion of the audio narration guide.

21. The computer-readable storage medium of claim 17, comprising instructions that when executed cause the system to generate a start touch event for a text sub-element of the text element when a position of the object enters an active area for the text sub-element.

22. The computer-readable storage medium of claim 17, comprising instructions that when executed cause the system to generate a stop touch event for a text sub-element of the text element when a position of the object exits an active area of the text sub-element.

23. The computer-readable storage medium of claim 17, comprising instructions that when executed cause the system to store a start time for an audio sub-element of the audio element corresponding to a text sub-element of the text element based on a start touch event for the text sub-element, and an end time for the audio sub-element of the audio element corresponding to the text sub-element of the text element based on a stop touch event for the text sub-element.

24. The computer-readable storage medium of claim 17, comprising instructions that when executed cause the system to storing the text element and the audio element in an annotated document file having a defined data format associated with a reader system.

25. An apparatus, comprising:
a processor circuit; and
a document recorder component arranged for execution by the processor circuit to receive a source document file and generate an annotated document file, the document recorder component arranged to retrieve a text element from the source document file, generate a user interface view with the text element and an audio narration guide proximate to the text element for presentation on an output device, receive positions of an object on the audio narration guide from an input device, and generate an audio element for the text element based on the positions.

26. The apparatus of claim 25, comprising a memory to store the text element and the audio element in an annotated document file having a defined data format associated with a reader system.

27. The apparatus of claim 25, the audio element comprising a single file corresponding to the text element or a portion of a single file corresponding to the text element.

28. The apparatus of claim 25, the input device comprising a touch-screen for an electronic display to receive positions of the object on the audio narration guide, the object comprising a human finger.

29. The apparatus of claim 25, comprising a microphone to capture audio narration of the text segment from a human voice to generate the audio element.

30. The apparatus of claim 25, comprising a wireless transceiver to communicate radio frequency (RF) electromagnetic signals representing the annotated document file to a reader system.

31. A computer-implemented method, comprising:
retrieving a text element and an audio element from an annotated document file;
generating a user interface view with the text element and an audio narration guide proximate to the text element for presentation on an electronic display;
receiving positions of an object on the audio narration guide; and
reproducing the audio element for the text element based on the positions.

32. The computer-implemented method of claim 31, comprising retrieving a text element from the annotated document file comprising a word, sentence, paragraph or page of a document.

33. The computer-implemented method of claim 31, comprising generating the user interface view with the text element presented as one or more lines of text on the user interface view, and the audio narration guide positioned directly beneath each line of text without any intervening line of text.

34. The computer-implemented method of claim 31, comprising generating a user interface view with the text element and the audio narration guide proximate to the text element, the audio narration guide comprising a start indicator corresponding to a start position for the text element, a text sub-element indicator corresponding to a text sub-element of the text element, a sub-element separation indicator corresponding to one or more spaces between text sub-elements of the text element, and an end indicator corresponding to an end position for the text element.

35. The computer-implemented method of claim 31, comprising defining a visible active area around each text sub-element of the text element and a corresponding portion of the audio narration guide.

36. The computer-implemented method of claim 31, comprising defining an invisible active area around each text sub-element of the text element and a corresponding portion of the audio narration guide.

37. The computer-implemented method of claim 31, comprising receiving positions of the object on the audio narration guide from a touch-screen display.

38. The computer-implemented method of claim 31, comprising generating a start touch event for a text sub-element of the text element when a position of the object enters an active area for the text sub-element.

39. The computer-implemented method of claim 31, comprising generating a stop touch event for a text sub-element of the text element when a position of the object exits an active area of the text sub-element.

40. The computer-implemented method of claim 31, comprising synchronizing the audio element and the text element.

41. The computer-implemented method of claim 31, comprising reproducing the audio element comprising an audio narration of the text element by a human voice.

42. The computer-implemented method of claim 1, comprising starting reproduction of the audio element at a start time for an audio sub-element of the audio element corresponding to a text sub-element of the text element based on a start touch event for the text sub-element.

43. The computer-implemented method of claim 1, comprising stopping reproduction of the audio element at an end time for an audio sub-element of the audio element corresponding to a text sub-element of the text element based on a stop touch event for the text sub-element.

44. At least one computer-readable storage medium comprising instructions that, when executed, cause a system to:
retrieve a text element and an audio element from an annotated document file;
generate a user interface view with the text element and an audio narration guide proximate to the text element for presentation on an electronic display;
receive positions of an object on the audio narration guide; and
reproduce the audio element for the text element based on the positions.

45. The computer-readable storage medium of claim 44, comprising instructions that when executed cause the system to generate the user interface view with the text element presented as one or more lines of text on the user interface view, and the audio narration guide positioned directly beneath each line of text without any intervening line of text.

46. The computer-readable storage medium of claim 44, comprising instructions that when executed cause the system to generate a start touch event for a text sub-element of the text element when a position of the object enters an active area for the text sub-element.

47. The computer-readable storage medium of claim 44, comprising instructions that when executed cause the system to generate a stop touch event for a text sub-element of the text element when a position of the object exits an active area of the text sub-element.

48. The computer-readable storage medium of claim 44, comprising instructions that when executed cause the system to start reproduction of the audio element at a start time for an audio sub-element of the audio element corresponding to a text sub-element of the text element based on a start touch event for the text sub-element.

49. The computer-readable storage medium of claim 40, comprising instructions that when executed cause the system to stop reproduction of the audio element at an end time for an audio sub-element of the audio element corresponding to a text sub-element of the text element based on a stop touch event for the text sub-element.

50. An apparatus, comprising:
a processor circuit; and
a document reader component arranged for execution by the processor circuit to retrieve a text element and an audio element from an annotated document file, generate a user interface view with the text element and an audio narration guide proximate to the text element for presentation on an output device, receive positions of an object on the audio narration guide from an input device, and reproduce the audio element for the text element based on the positions.

51. The apparatus of claim 50, comprising a memory to store the text element and the audio element in an annotated document file having a defined data format.

52. The apparatus of claim 50, the output device comprising an electronic display to present the user interface view.

53. The apparatus of claim 50, the input device comprising a touch-screen for an electronic display to receive positions of the object on the audio narration guide, the object comprising a human finger.

54. The apparatus of claim 50, comprising a speaker to reproduce the audio element comprising an audio narration of the text segment from a human voice.

55. The apparatus of claim 50, comprising a wireless transceiver to communicate radio frequency (RF) electromagnetic signals representing the annotated document file from a document recorder component.
